(19) United States
(12) Patent Application Publication
(10) Pub. No.: US 2006/0013632 A1
(43) Pub. Date: Jan. 19, 2006

(54) Multi-color image forming method

(76) Inventors: Akihiro Shimomura, Shizuoka (JP); Mitsuru Yamamoto, Shizuoka (JP); Shinichi Yoshinari, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/498,934

(22) PCT Filed: Dec. 17, 2002
(86) PCT No.: PCT/JP02/13197

§ 371 Date: Jul. 11, 2005

(30) Foreign Application Priority Data
Dec. 17, 2001 (JP) 2001-383330
Jan. 28, 2002 (JP) 2002-18536
Jan. 30, 2002 (JP) 2002-22015

(51) Int. Cl. B41J 2/315

(52) U.S. Cl. 400/120.02

(57) ABSTRACT

A multi-color image-forming process is provided, which comprises a step of transferring an image to an image-receiving sheet by irradiating a heat transfer sheet with laser light in a recording device provided with a recording drum to form the image on the image-receiving sheet, wherein (a) the heat trasfer sheet comprises a image forming layer having Rz of the surface of 0.5 to 2.5 μm, the image-receiving sheet comprises a image-receiving layer having Rz of the surface of 0.5 to 1.5 μm, the image-receiving sheet has a longitudinal thermal shrinkage of 1.0% or less, the image-receiving sheet has a crosswise thermal shrinkage of 1.0% or less, and the a multi-color image-forming process comprises a step of retransferring the image which has been transferred to the image-receiving sheet to a final image carrier, the retransferring is effected using a pair of heated rolls each having a diameter ranging from 50 mm to 350 mm wherein the temperature of the various rolls are set to from 80° C. to 250° C.; (b) wherein the multi-color image-forming process comprises a step of cleaning a surface of the heat transfer sheet and a surface of the image-receiving sheet by bringing the heat transfer sheet and the image-receiving sheet into contact with a pressure-sensitive adhesive roller having a pressure-sensitive adhesive material on a surface of the roll, the pressure-sensitive adhesive roller being provided either at a section where the heat transfer sheet is fed or transported, or at a section where the image-receiving sheet is fed or transported, the pressure-sensitive adhesive roller has a pressure-sensitive adhesive material having a hardness (JIS-A) of 15 to 90, the heat transfer sheet comprises a image-forming layer having a Smoothster value of 1.0 to 20 mmHg (0.13 to 2.7 kPa), and the image-receiving layer has a surface having a Smoothster value of 0.5 to 30 mmHg (0.07 to 4.0 kPa); or (c) both the longitudinal stiffness (Msr) and the crosswise stiffness (Tsr) of the image-receiving sheet are from 40 to 90 g, Msr/Tsr is from 0.75 to 1.20, the surface roughness of the aforesaid recording drum and image-receiving layer each are from 0.01 to 12 μm as calculated in terms of Rz, and the diameter of the aforesaid recording drum is 250 mm or more.

### TECHNICAL FIELD

The present invention relates to a multi-color image-forming process for forming a full-color image having a high resolution by using laser light. More particularly, the present invention relates to a multi-color image-forming process useful for the preparation of a color proof (DDCP: direct digital color proof) or mask image in the art of printing by laser recording from digital image signal.

### BACKGROUND ART

In the graphic art, a printing plate is made from a set of color separation films prepared from a color original by a lithographic film. In general, in order to check error in the color separation step or necessity for color correction before the final printing (actual printing), a color proof is prepared from the color separation films. It is desirable that the color proof has a high resolving power allowing a high reproducibility of halftone image, or a high stability of processing. In order to obtain the color proof approximating the actual printed matter, the color proof is preferably made of the material to be used in the actual printed matter, e.g., final printing paper as a substrate and pigment as a colorant. It is extremely desirable that the color proof is prepared by a dry process in the absence of developer.

As the dry process for the preparation of a color proof, a recording system for preparing a color proof directly from a digital signal has been developed with the recent spread of an electronizing system in preprocessing of printing (pre-press field). Such an electronizing system is particularly adapted for the preparation of a high quality color proof and normally reproduces a halftone image having a precision of not lower than 150 lines/inch. In order to record a high quality proof from a digital signal, laser light, which can be modulated with a digital signal and can be converged to form a fine recording beam, is used as a recording head. To this end, it is necessary that an image-forming material is developed which exhibits a high recording sensitivity to laser light and a high resolving power allowing reproduction of a high precision halftone dot.

As an image-forming material to be used in the transfer image-forming process by using laser light, a hot-melt transfer sheet has been known, the hot-melt transfer sheet comprising a light-to-heat conversion layer which absorbs laser light to generate heat and an image-forming layer having a pigment dispersed in a hot-melt wax, binder or the like, provided in this order on a support (JP-A-5-58045). In an image-forming process by using such an image-forming material, heat generated in the laser light-irradiated area on the light-to-heat conversion layer causes the image-forming layer corresponding to that area to be melted and transferred to the image-receiving sheet superposed on the transfer sheet, so that a transfer image is formed on the image-receiving sheet.

Further, JP-A-6-219052 discloses a heat transfer sheet comprising a light-to-heat conversion layer containing a light-to-heat conversion material, a heat peel layer having a very thin (0.03 μm to 0.3 μm), and an image-forming layer containing a colorant, provided in this order on a support. When this heat transfer sheet is irradiated with laser light, the adhesion between the image-forming layer and the light-to-heat conversion layer, which are bonded to each other with the heat peel layer interposed between the image-forming layer and the light-to-heat conversion layer, is lowered to form a high precision image on the image-receiving sheet superposed on the heat transfer sheet. The image-forming process with the heat transfer sheet involves so-called “ablation”, and in some detail, a phenomenon is used that a part of the heat peel layer decomposes and vaporizes at the area irradiated with a laser light, thereby the adhesion between the image-forming layer and the light-to-heat conversion layer at that area is reduced, and the image-forming layer at that area is transferred to the image-receiving sheet superposed on the heat transfer sheet.

These image-forming processes are advantageous in that a final printing paper comprising an image-receiving layer (adhesive layer) may be used as an image-receiving sheet material, and a multi-color image can be easily obtained by sequentially transferring images having different colors onto the image-receiving sheet. In particular, the image-forming process using ablation is advantageous in that a high precision image can be easily obtained and is useful for the preparation of a color proof (DDCP: direct digital color proof) or a high precision mask image.

With the progress of DTP environment, CTP (Computer to Plate) system has been needed more for DDCP process proof than for proof sheet or analog process proof because it requires no step of withdrawing intermediate film, and in recent years, a large-sized DDCP having a high quality, a high stability and an excellent coincidence with desired printed matter has been desired.

A laser heat transfer process allows printing with a high resolution, and a laser heat transfer process has heretofore been effected in various processes such as \textcircled{1} laser sublimation process, \textcircled{2} laser ablation process and \textcircled{3} laser melt process, but all these processes were disadvantageous in that the resulting recorded halftone dot is not sharp. In some detail, the laser sublimation process \textcircled{1} involves the use of a dye as a colorant and thus is disadvantageous in that the approximation to desired printed matter is insufficient, and this process also involves the sublimation of a colorant and thus is disadvantageous in that the resulting halftone dot has a blurred contour, giving an insufficient resolution. On the other hand, the laser ablation process involves the use of a pigment as a colorant and thus provides a good approximation to desired printed matter, but this process involves the scattering of a colorant and thus is disadvantageous in that the resulting halftone dot has a blurred contour, giving an insufficient resolution as in the laser sublimation process. Further, the laser melt process \textcircled{3} involves the flow of molten material and thus is disadvantageous in that the resulting image has no clear contour.

A further problem is that wrinkle is generated in transferring to thin paper as final paper or peeling occurs in transferring to non-coated paper as final paper, leaving something to be desired in transferability to final paper.

Moreover, when recording is effected with dust attached to the surface of the image-forming layer of the heat transfer sheet or the surface of the image-receiving layer of the image-receiving sheet or the back surface of the image-receiving sheet, the image which should be transferred is left untransferred, drastically impairing the image quality, and the removal of dust from the recording material (cleaning) is very important. Referring to function of removing dust, the higher an adhesion of a pressure-sensitive adhesive roller is, the higher is the function of removing dust, but the worse is a problem in transporting such as sticking to the pressure-sensitive adhesive roller.

On the other hand, a countermeasure taking into account the image-forming material can be proposed against image lack due to dust, and it has been found important to provide the image-forming material with some surface roughness.

However, in order to form a large size multi-color image having a high-resolution by using a laser heat transfer process, an optimum relationship between the adhesion of the pressure-sensitive adhesive roller and the surface roughness of the image-forming material is needed, but this relationship is still unknown.

A still further problem is that when the size of the multi-color image rises, it is made difficult to secure the desired adhesion between the recording drum and the image-receiving sheet and between the image-receiving sheet and the heat transfer sheet and hence stable and good image quality.

### DISCLOSURE OF THE INVENTION

An object of the present invention is to solve the aforesaid problems and provide multi-color image-forming process capable of giving a large-sized DDCP having a high quality, a high stability or an excellent coincidence with desired printed matter. In some detail, an object of the present invention is to provide a multi-color image-forming material and a multi-color image-forming process which allow the followings:
1) A heat transfer sheet exhibits, by transferring colorant of thin film free from the influence of light sources, an excellent sharpness of a halftone dot and stability comparable to pigment colorant and printed matters;
2) An image-receiving sheet can securely receive the image-forming layer of laser energy heat transfer sheet in a stable manner and exhibits a good transferability to mat-coated paper, high quality paper (paper with surface roughness) or the like as final paper;
3) An image can be transferred to final paper having a basis weight of at least 64 to 157 g/m² as in art (coated) paper, matted paper, slightly coated paper, etc. and a close description of texture or accurate reproduction of paper white (high key portion) can be made; and
4) A good quality image having a stable transfer density can be formed on the image-receiving sheet even when laser recording is effected with a laser light which is a multi-beam at a high energy under different temperature and humidity conditions.

In particular, one of the objects of the present invention is to provide a multi-color image-forming process which is less subject to generation of wrinkle in transferring to thin paper as final paper and generation of peeling in transferring to non-coated paper as final paper and thus exhibits an improved transferability to final paper.

Further, another object of the present invention is to provide a multi-color image-forming process which can provide a transfer image having little image lack due to dust even when the multi-color image-forming material has a large size.

Moreover, a further object of the present invention is to provide a multi-color image-forming process which can provide an excellent adhesion between the recording drum and the image-receiving sheet, and between the image-receiving sheet and the heat transfer sheet, even when the multi-color image-forming material has a large size, and thus invariably provide a high image quality.

In other words, means of accomplishing the aforesaid objects are as follows.

(1) A multi-color image recording process, which comprises:
a step (I) of rolling out (or unwinding) a rolled heat transfer sheet having a light-to-heat conversion layer and an image-forming layer, and a rolled image-receiving sheet having an image-receiving layer, the image-receiving sheet being wound with the image-receiving layer outside, into an exposure recording device; superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other; and retaining the superposed heat transfer sheet and the image-receiving sheet on an exposure drum of the exposure recording device;
a step (II) of transferring an image to the image-receiving sheet by a heat converted from a laser light, the laser light being absorbed in the light-to-heat conversion layer of the heat transfer sheet upon irradiation with the laser light according to image data; and
a step (III) of retransferring the image which has been transferred to the image-receiving sheet to a final image carrier, wherein a) the image-forming layer in the heat transfer sheet has a surface having Rz of 0.5 to 2.5 μm, b) the image-receiving layer in the image-receiving sheet has a surface having Rz of 0.5 to 1.5 μm, c) the image-receiving sheet has a longitudinal thermal shrinkage of 1.0% or less and a crosswise thermal shrinkage of 1.0% or less, and d) in the step (III) of retransferring the image to the final image carrier, the retransferring is effected by using a pair of heated rolls each having a diameter ranging from 50 mm to 350 mm wherein the rolls are set to a temperature of 80° C. to 250° C.

(2) A multi-color image-forming process, which comprises:
rolling out a rolled heat transfer sheet and a rolled image-receiving sheet having an image-receiving layer, the image-receiving sheet being wound with the image-receiving layer outside;
superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other;
retaining the superposed heat transfer sheet and the image-receiving sheet on a recording drum; and
transferring an image to the image-receiving sheet by a heat converted from a laser light, the laser light being absorbed in the light-to-heat conversion layer of the heat transfer sheet upon irradiation with the laser light according to image data, so that the image is formed on the image-receiving sheet;
wherein the multi-color image-forming process comprises a step of cleaning a surface of the heat transfer sheet and a surface of the image-receiving sheet by bringing the heat transfer sheet and the image-receiving sheet into contact with a pressure-sensitive adhesive roller having a pressure-sensitive adhesive material on a surface of the roll, the pressure-sensitive adhesive roller being provided either at a section where the heat transfer sheet is fed or transported, or at a section where the image-receiving sheet is fed or transported;
the pressure-sensitive adhesive roller has a pressure-sensitive adhesive material having a hardness (JIS-A) of 15 to 90;
the heat transfer sheet comprises a image-forming layer having a Smoothster value of 1.0 to 20 mmHg (0.13 to 2.7 kPa); and
the image-receiving layer has a surface having a Smoothster value of 0.5 to 30 mmHg (0.07 to 4.0 kPa).

(3) A multi-color image-forming process, which comprises:
rolling out a rolled heat transfer sheet and a rolled image-receiving sheet having an image-receiving layer, the image-receiving sheet being wound with the image-receiving layer outside;
superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other;
retaining the superposed heat transfer sheet and the image-receiving sheet on a recording drum; and
transferring an image to the image-receiving sheet by a heat converted from a laser light, the laser light being absorbed in the light-to-heat conversion layer of the heat transfer sheet upon irradiation with the laser light according to image data, so that the image is formed on the image-receiving sheet;
wherein the image-receiving sheet has a longitudinal stiffness (Msr) of 40 to 90 g, a crosswise stiffness (Tsr) of 40 to 90 g, and an Msr/Tsr of 0.7 to 1.20; the recording drum has a surface having a surface roughness of 0.10 to 12 μm in terms of Rz value and the image-receiving has a surface having a surface roughness of 0.10 to 12 μm in terms of Rz value; and the recording drum has a diameter of 250 mm or more.

(4) The multi-color image-forming process of any one of (1) to (3), wherein the transferred image has a resolution of 2,400 dpi or more.

(5) The multi-color image recording process of any one of (1) to (4), wherein the image-forming layer in the heat transfer sheet has a ratio (OD/layer thickness) of the optical density (OD) to the thickness (μm) of 1.50 or more.

(6) The multi-color image recording process of any one of (1) to (5), wherein the image-forming layer in the heat transfer sheet has a ratio (OD/layer thickness) of the optical density (OD) to the thickness (μm) of 2.50 or more.

(7) The multi-color image recording process of any one of (1) to (6), wherein the image-forming layer in the heat transfer sheet has a contact angle of water of 7.0 to 120.0° and the image-receiving layer in the image-receiving sheet has a contact angle of water of 7.0 to 120.0°.

(8) The multi-color image recording process of any one of (1) to (7), wherein the multi-color image has a recording area of 515 mm or more×728 mm or more.

(9) The multi-color image recording process of any one of (1) to (8), wherein the image-forming layer in the heat transfer sheet has a ratio (OD/layer thickness) of the optical density (OD) to the thickness (μm) of 1.80 or more, and the image-receiving sheet has a contact angle of water of 86° or less.

### BRIEF DESCRIPTION OF THE DRAWINGS

FIG. 1 is a diagram illustrating the outline of the mechanism of forming a multi-color image by a thin film heat transfer by using laser.

FIG. 2 is a diagram illustrating an example of the arrangement of laser heat transfer recording device.

FIG. 3 is a diagram illustrating an example of the arrangement of heat transfer device.

FIG. 4 is a diagram illustrating an example of the arrangement of system comprising laser heat recording device FINALPROOF.

### BEST MODE FOR CARRYING OUT THE INVENTION

We made extensive studies of DDCP having a size as large as not smaller than B2/A2, even not smaller than B1/A1, which exhibits a high quality, a high stability and an excellent coincidence with desired printed matter. As a result, we have developed an image-forming material having a size of not smaller than B2 of the type, allowing transfer to final paper, output of an actual halftone dot and use of pigment, and a laser heat transfer recording system for DDCP comprising an outputting machine and a high quality CMS soft ware.

The features of performance, system arrangement and outline of technical points of the laser heat transfer recording system we developed will be described hereinafter. The features of performance of the laser heat transfer recording system are as follows:
\textcircled{1} Since this system can print a sharp dot, a halftone dot with an excellent approximation to desired printed matter can be reproduced;
\textcircled{2} This system provides a color hue having a good approximation to desired printed matter;
\textcircled{3} Since this system is little subject to the effect of ambient temperature and humidity on the record quality and provides a good reproducibility in repetition, a stable proof can be prepared; and
\textcircled{4} The image-receiving sheet can receive the image-forming layer of a laser energy heat transfer sheet stably and certainly and has a good transferability to good quality paper (paper with surface roughness) as final paper.

One of the technical points of the material which can provide these features of performance is that a thin film transfer technique has been established and another point is the improvement of retention of vacuum adhesion, response to high resolution recording and heat resistance of the material required for laser heat transfer system. Specific examples of these technical points are as follows:
\textcircled{1} To reduce the thickness of the light-to-heat conversion layer by employing an infrared-absorbing dye;
\textcircled{2} To enhance the heat resistance of the light-to-heat conversion layer by employing a high Tg polymer;
\textcircled{3} To stabilize color hue by employing a heat-resistant pigment;
\textcircled{4} To control the adhesion/cohesive force by adding a low molecular component such as wax and inorganic pigment; and
\textcircled{5} To provide desired vacuum adhesion without image deterioration by incorporating a matting agent in the light-to-heat conversion layer.
   The technical points of this system are as follows:
\textcircled{1} The recording device performs air-aided conveyance to allow continuous accumulation of a plurality of sheets;
\textcircled{2} The final paper while being disposed upon the image-receiving sheet is inserted into the heat transferring device to minimize the occurrence of curling after transfer; and
\textcircled{3} A general-purpose output driver allowing expansion of system connection is connected to the system.
   Thus, the laser heat transfer recording system we developed has various features of performance, system arrangements and technical points. However, these features of performance, system arrangements and technical points are only illustrative, and the present invention is not limited to these means.

We made this development on the basis of a concept that the individual materials, the various coat layers such as light-to-heat conversion layer, image-forming layer and image-receiving layer, and the heat transfer sheet and image-receiving sheet should not be provided separately but should be provided so as to give a comprehensive and functional performance and these image-forming materials should be combined with a recording device or a heat transferring device to accomplish the best performance. We selected various coat layers of image-forming material and constituent materials with the greatest care to prepare coat layers of image-forming material which make the best use of the advantages of these materials and found a proper range of various physical properties within which these image-forming materials accomplish their performance at maximum. As a result, we made an exhaustive study of the relationship between the various materials, coat layers and sheets and the physical properties and unexpectedly found a high performance image-forming material by allowing these image-forming materials to give a comprehensive and functional performance with a recording device or heat transferring device.

The significance of the present invention in the system we developed is the provision of a multi-color image-forming process suitable for the implementation of such a system, and in particular, the first invention of the present invention is an important invention that provides a multi-color image-forming process which is less subject to generation of wrinkle in transferring to thin paper as final paper and generation of peeling in transferring to non-coated paper as final paper and thus exhibits an improved transferability to final paper.

The multi-color image-forming process in the first invention of the present invention comprises: a step (I) of rolling out (or unwinding) a rolled heat transfer sheet having a light-to-heat conversion layer and an image-forming layer, and a rolled image-receiving sheet having an image-receiving layer, the image-receiving sheet being wound with the image-receiving layer outside, into an exposure recording device; superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other; and retaining the superposed heat transfer sheet and the image-receiving sheet on an exposure drum of the exposure recording device; a step (II) of transferring an image to the image-receiving sheet by a heat converted from a laser light, the laser light being absorbed in the light-to-heat conversion layer of the heat transfer sheet upon irradiation with the laser light according to image data; and a step (III) of retransferring the image which has been transferred to the image-receiving sheet to a final image carrier, wherein the image-forming layer in the heat transfer sheet has a surface having Rz of 0.5 to 2.5 μm; the image-receiving layer in the image-receiving sheet has a surface having Rz of 0.5 to 1.5 μm; the image-receiving sheet has a longitudinal thermal shrinkage of 1.0% or less and a crosswise thermal shrinkage of 1.0% or less; and the retransferring is effected by using a pair of heated rolls each having a diameter ranging from 50 mm to 350 mm wherein the rolls are set to a temperature of 80° C. to 250° C.

In this manner, a high quality image can be obtained, and a good final paper transferability, i.e., inhibition of generation of wrinkle in transferring to thin paper as final paper and peeling in transferring to non-coated paper as final paper can be realized.

In the present invention, surface roughness Rz is meant to indicate ten-point average roughness corresponding to Rz (maximum height) defined by the Japanese Industrial Standard (JIS), which is calculated from the distance between the height averaged over values ranging from the highest value to the fifth highest value and the depth averaged over values ranging from the deepest value to the fifth deepest value on the averaged reference area extracted from roughened curved surface as reference surface. For the measurement of surface roughness Rz, a feeler type three-dimensional roughness meter (SURFCOM 570A-3DF) produced by TOKYO SEIMITSU CO., LTD. The measurement direction is longitudinal, the cut-off value is 0.08 mm, the measurement area is 0.6 mm×0.4 mm, the feed pitch is 0.005 mm, and the measuring speed is 0.12 mm/s.

In the present invention, as mentioned above, the image-receiving layer has a longitudinal thermal shrinkage of 1% or less, preferably 0.5% or less, and a crosswise thermal shrinkage of 1% or less, preferably 0.5% or less. The requirements for thermal shrinkage of the image-receiving sheet are normally satisfied by selecting a proper support.

Next, the second invention which is one of other inventions of the present invention provides a multi-color image-forming process suitable for the aforementioned system we developed, and in particular, the second invention is positioned as an important invention that provides a multi-color image-forming process capable of providing a transfer image having little defects due to dust.

The multi-color image-forming process in the second invention of the present invention comprises: rolling out a rolled heat transfer sheet and a rolled image-receiving sheet having a image-receiving layer, the image-receiving sheet being wound with the image-receiving layer outside; superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other; retaining the superposed heat transfer sheet and the image-receiving sheet on a recording drum of a recording device; and transferring an image to the image-receiving sheet by a heat converted from a laser light, the laser light being absorbed in the light-to-heat conversion layer of the heat transfer sheet upon irradiation with the laser light according to image data, so that the image is formed on the image-receiving sheet; wherein the multi-color image-forming process comprises a step of cleaning a surface of the heat transfer sheet and a surface of the image-receiving sheet by bringing the heat transfer sheet and the image-receiving sheet into contact with a pressure-sensitive adhesive roller having a pressure-sensitive adhesive material on a surface of the roll, the pressure-sensitive adhesive roller being provided either at a section of the recording device where the heat transfer sheet is fed or transported, or at a section of the recording device where the image-receiving sheet is fed or transported; the pressure-sensitive adhesive roller has a pressure-sensitive adhesive material having a hardness (JIS-A) of 15 to 90; the heat transfer sheet comprises a image-forming layer having a Smoothster value of 1.0 to 20 mmHg (0.13 to 2.7 kPa); and the image-receiving layer has a surface having a Smoothster value of 0.5 to 30 mmHg (0.07 to 4.0 kPa).

The pressure-sensitive adhesive roller is provided either at a section of the recording device where the heat transfer sheet is fed or transported, or at a section of the recording device where the image-receiving sheet is fed or transported. The pressure-sensitive adhesive roller may be provided at both said sections. The pressure-sensitive adhesive roller preferably also acts as a conveyance roller as described later, but a pressure-sensitive adhesive roller dedicated only for cleaning may be provided. The pressure-sensitive adhesive roller may be a single roller or may be counterpart of a pair of rollers so far as it is provided in such an arrangement that the pressure-sensitive adhesive roller at least comes in contact with the surface of the image-forming layer or the image-receiving layer. In the latter case, at least one of the two rollers needs to be a pressure-sensitive adhesive roller, and the other may or may not be a pressure-sensitive adhesive roller but is preferably a pressure-sensitive adhesive roller. Further, the heat transfer sheet and the image-receiving sheet may each be cleaned by a plurality of pressure-sensitive adhesive rollers during the period from rolling out till retaining on the recording drum.

The pressure-sensitive adhesive roller needs to have a surface comprising a pressure-sensitive adhesive material, the pressure-sensitive adhesive material having a hardness (JIS-A) of 15 to 90. When the hardness of the pressure-sensitive adhesive material is less than 15, the adhesion is too strong, causing deterioration of transporting properties such as winding on the pressure-sensitive adhesive roller. Further, when the hardness of the pressure-sensitive adhesive material is more than 90, the adhesion is reduced, making it impossible to exert the cleaning effect.

The amount of the pressure-sensitive adhesive material to be retained on the surface of the pressure-sensitive adhesive roller can be properly adjusted. Further, a plurality of pressure-sensitive adhesive materials having different hardnesses may be provided on the surface of the same pressure-sensitive adhesive roller in mosaic, striped or like pattern, or pressure-sensitive adhesive materials having different hardnesses may be used in separate pressure-sensitive adhesive rollers.

Further, the axial length of the pressure-sensitive adhesive roller is preferably not smaller than the roll width of the heat transfer sheet and image-receiving sheet but is not specifically limited, and a desired number of pressure-sensitive adhesive rollers having a desired size may be provided over the transport section between the section of rolling out the rolled heat transfer sheet or the rolled image-receiving sheet and the section of retention of the heat transfer sheet or the image-receiving sheet on the recording drum.

Further, the image-forming layer in the heat transfer sheet has a Smoothster value of 0.1 to 20 mmHg (0.13 to 2.7 kPa), preferably 5 to 15 mmHg (0.65 to 2.03 kPa), and the image-receiving layer has a surface having a Smoothster value of 0.5 to 30 mmHg (0.07 to 4.0 kPa), preferably 5 to 20 mmHg (0.7 to 2.7 kPa). The Smoothster values are preferably adjusted to above values to effect cleaning by the aforesaid pressure-sensitive adhesive roller more effectively.

Moreover, the above-described Smoothster values are also effective to secure the adhesion between the image-forming layer and the image-receiving layer as described later.

In the present application, the aforesaid various Smoothster values are measured by a Type DSM-2 digital Smoothster (Toei Electronics Co., Ltd.).

As a means of adjusting the Smoothster value there may be used adjustment of the surface roughness of the image-forming layer and the image-receiving layer, and for example, there may be used incorporation of a powder of matting agent or the like in the various layers constituting the heat transfer sheet or the image-receiving sheet.

Further, the third invention which is further one of the other inventions of the present invention provides a multi-color image-forming process suitable for the aforesaid system we developed, and in particular, the third invention is positioned as an important invention that provides a multi-color image-forming process excellent in recording drum/image-receiving sheet/heat transfer sheet adhesion capable of stably providing a high image quality.

The multi-color image-forming process in the third invention of the present invention comprises: rolling out a rolled heat transfer sheet and a rolled image-receiving sheet having a image-receiving layer, the image-receiving sheet being wound with the image-receiving layer outside; superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other; retaining the superposed heat transfer sheet and the image-receiving sheet on a recording drum; and transferring an image to the image-receiving sheet by a heat converted from a laser light, the laser light being absorbed in the light-to-heat conversion layer of the heat transfer sheet upon irradiation with the laser light according to image data, so that the image is formed on the image-receiving sheet; wherein the image-receiving sheet has a longitudinal stiffness (Msr) of 40 to 90 g, a crosswise stiffness (Tsr) of 40 to 90 g, and an Msr/Tsr of 0.7 to 1.20; the recording drum has a surface having a surface roughness of 0.10 to 12 μm in terms of Rz value and the image-receiving has a surface having a surface roughness of 0.10 to 12 μm in terms of Rz value; and the recording drum has a diameter of 250 mm or more.

In particular, in the third invention, the stiffness of the image-receiving sheet, the Rz of the surface of the recording drum and the image-receiving layer and the diameter of the recording drum are predetermined.

In the present invention, the stiffness of the image-receiving sheet, i.e., the Msr and the Tsr were measured by a loop stiffness tester produced by Toyo Seiki Seisaku-Sho, Ltd. The width of the sample was 2 cm, and the length of the sample was great enough to extend over the measuring instrument. Further, measurement was effected with the measuring surface of the sample upside. Moreover, the longitudinal direction indicates longer direction of the roll and the crosswise direction indicates width direction of the roll.

An Msr and a Tsr are predetermined to be 40 to 90 g, preferably 60 to 80 g, respectively. An Msr/Tsr is predetermined to be 0.75 to 1.20, preferably 0.85 to 1.15.

As means of controlling Msr of the image-receiving sheet and Tsr of the image-receiving sheet the following means may be exemplified, but the present invention is not limited thereto.
(1) To select the material of the support to be used in the image-receiving sheet; and
(2) To control the kind and amount of binder, powder, additives and other components constituting various layers such as image-receiving layer to be formed on the support

The details of the aforesaid means will be later described in organic integration of other technical problems.

In the present invention, Rz of the surface of the recording drum and the image-receiving layer are each adjusted to 0.01 to 12 μm. Rz as used herein has the same meaning as said Rz mentioned above.

Further, in the present invention, a diameter of the recording drum is predetermined to 250 mm or more.

Moreover, in all the first to fourth inventions, the image-forming layer in the heat transfer sheet has a ratio OD/T (unit: μm) of the optical density (OD) to the thickness T of preferably 1.50 or more, more preferably 1.80 or more, particularly 2.50 or more. The upper limit of OD/T is not specifically limited and preferably as great as possible, but is about 6 at maximum in the state of the art taking into account balance with other properties.

The Od/T is a measure of the transfer density of the image-forming layer and the resolution of the transfer image. By predetermining an OD/T within the above-described range, an image having a high transfer density and a good resolution can be obtained. Further, by further reducing the thickness of the image-forming layer, the color reproducibility can be enhanced.

In the present invention, it is preferred that heat transfer sheets for at least four colors are used as the heat transfer sheet for image-forming materials, and the image-forming materials preferably comprises four or more heat transfer sheets having at least yellow, magenta, cyan or black image-forming layers.

OD indicates the reflection optical density obtained by measuring an image transferred to Tokubishi art paper as final paper from the image-receiving sheet to which the image has been transferred from the heat transfer sheet in various color modes of optical density of yellow (Y), magenta (M), cyan (C) and black (K) using a Type X-rite 938 densitometer (produced by X-rite Inc.).

An OD is preferably 0.5 to 3.0, more preferably 0.8 to 2.0.

The adjustment of the optical density of the image-forming layer can be carried out by selecting pigments to be used or changing the dispersed particle diameter of the pigments to be used.

In the present invention, an image can be recorded under the conditions that the transfer image has a resolution of preferably 2,400 dpi or more, more preferably 2,600 dpi or more, and the heat transfer sheet has a recording area of preferably 515 mm or more×728 mm or more, more preferably 594 mm or more×841 mm or more. The image-receiving sheet has a size of preferably 465 mm or more×686 mm or more.

In the present invention, a ratio OD/T (unit: μm) of the optical density (OD) of the light-to-heat conversion layer of the heat transfer sheet to the thickness T of the light-to-heat conversion layer is preferably controlled to 4.36 or more to obtain the above-described size and resolution. The upper limit of OD/T is not specifically limited and preferably as great as possible, but is about 10 at maximum in the state of the art taking into account balance with other properties.

OD of the heat transfer sheet indicates the absorbance of the light-to-heat conversion layer measured at the peak wavelength of laser light, the laser light be used in recording with image-forming materials of the present invention, and can be measured by any known spectrophotometer. In the present invention, a Type UV-240 UV spectrophotometer produced by Shimadzu Corporation was used. Further, the above-described OD is the value obtained by subtracting the value of the support alone from the value of the heat transfer sheet, including the support.

OD/T is related to the heat conductivity during recording and is an index that drastically governs the dependence of sensitivity and recording properties on temperature and humidity. By predetermining OD/T within the above-described range, the sensitivity of transfer to the image-receiving sheet in recording can be raised and the dependence of recording properties on temperature and humidity can be reduced.

The light-to-heat conversion layer has a thickness of preferably 0.03 to 1.0 μm, more preferably 0.05 to 0.5 μm.

Further, in the present invention, the image-forming layer in the heat transfer sheet has a contact angle of water of preferably 7.0 to 120.0°, and the image-forming layer of the heat transfer sheet and the image-receiving layer in the image-receiving sheet has a contact angle of water of preferably 7.0 to 120.0°. Contact angle is an index concerning the compatibility of the image-forming layer with the image-receiving layer, i.e., transferability. The contact angle of water is more preferably 30.0 to 100.0°. Further, the image-receiving layer has the contact angle of water of more preferably 86° or less. When the contact angle is predetermined to the above-described range, the sensitivity of transfer can be raised, and it is desirable because the dependence of recording properties on temperature and humidity can be reduced.

The contact angle of the surface of the various layers of the present invention is measured by a Type CA-A contact angle meter (produced by Kyowa Interface Science Co., LTD).

The entire system we developed, including the content of the present invention, will be described hereinafter. In the system of the present invention, a thin film heat transfer process was invented and employed to attain a high resolution and a high image quality. The system of the present invention can provide a transfer image having a resolution of not smaller than 2,400 dpi, preferably not smaller than 2,600 dpi. A thin film heat transfer process comprises transferring an image-forming layer having a thickness as small as 0.01 μm to 0.9 μm to an image-receiving layer in partly unmelted form or little melted form. In other words, a heat transfer process having an extremely high resolution attained by the transfer of recorded area in the form of thin film was developed. A preferred method for efficiently effecting thin film heat transfer comprises effecting optical recording to deform the interior of the light-to-heat conversion layer into a dome so that the image-forming layer is pushed up to enhance the adhesion between the image-forming layer and the image-receiving layer, facilitating transferring. When the deformation is great, the resulting pushing power of the image-forming layer against the image-receiving layer is increased to facilitate transferring. On the contrary, when the deformation is small, the resulting pushing power of the image-forming layer against the image-receiving layer is small, leaving some areas insufficiently transferred. The deformation suitable for thin film transfer will be described hereinafter. The deformation is observed under a laser microscope (Type VK8500, produced by KEYENCE CORPORATION). The magnitude of deformation can be evaluated by percent deformation calculated by the multiplication of the division of the sum of the increase (a) of the cross-section area of the recorded area on the light-to-heat conversion layer after recording and the cross-section area (b) of the recorded area on the light-to-heat conversion layer before recording by the cross-section area (b) by 100, i.e., {(a+b)/(b)}×100. The percent deformation is not smaller than 110%, preferably not smaller than 125%, more preferably not smaller than 150%. If the elongation at break of the sheet is predetermined great, the percent deformation may be greater than 250%. However, it is usually preferred that the percent deformation be kept to not greater than about 250%.

The technical points of the image-forming material in the thin film transfer are as follows:

1. Both a high heat response and storage properties are attained.

In order to attain a high image quality, it is necessary that a film having a thickness on the order of submicron be transferred. However, in order to provide a desired density, it is necessary that a layer having a pigment dispersed therein in a high concentration be prepared. This conflicts with heat response. Heat response conflicts with storage properties (adhesion). These conflicts were eliminated by the development of novel polymers/additives.

2. A high vacuum adhesion is secured.

In the thin film transfer process requiring a high resolution, the transfer interface is preferably smooth, but sufficient vacuum adhesion cannot be obtained when the transfer interface is smooth. By incorporating a matting agent having a relatively small particle diameter in the layer under the image-forming layer in a relatively large amount without sticking to the old common sense of providing vacuum adhesion, a proper gap can be uniformly kept between the heat transfer sheet and the image-receiving sheet, making it possible to provide desired vacuum adhesion while maintaining the characteristics of thin layer transfer without causing image lack due to matting agent.

3. Use of heat-resistant organic material

During laser recording, the temperature of the light-to-heat conversion layer, which converts laser light to heat, and the image-forming layer, which contains pigment colorants, reach as high as about 700° C. and about 500° C., respectively. As the material of the light-to-heat conversion layer, a modified polyimide coatable with an organic solvent was developed, and as a pigment colorant, a pigment which exhibits a higher heat resistance and safety than printing pigment and the same hue as printing pigment was developed.

4. Securing surface cleanness

In the thin film transfer process, dust present between the heat transfer sheet and the image-receiving sheet causes image defects and thus is a serious problem. Dust from the exterior of the apparatus enters the gap between the heat transfer sheet and the image-receiving sheet or occurs when the material is cut and thus cannot be sufficiently prevented merely by material control, and it is necessary that the apparatus be provided with a dust removing mechanism, but a material which can maintain a proper adhesion that allows the cleaning of the surface of the transfer material was found, and by changing the material of the conveying roller, the removal of dust was realized without deteriorating productivity.

The system of the present invention will be described in detail hereinafter.

The present invention preferably realizes the formation of a heat transfer image by sharp halftone dots and allows image transfer to final paper and image recording with a size of not smaller than B2 (515 mm×728 mm). More preferably, B2 size is 543 mm×841 mm. The system of the present invention allows image recording on paper having a size of not smaller than this B2 size.

One of the features of the system developed in the present invention is that sharp halftone dots can be obtained. The heat transfer image obtained in this system has a resolution of not smaller than 2,400 dpi, and can be a halftone image formed according to the number of printed lines. Since every dot has little or no stain and lacks and has a very sharp shape, halftone can be clearly formed over a wide range of from highlighted area to shadow. As a result, the system of the present invention can output a high quality halftone at the same resolution as in image setter or CTP setter, making it possible to reproduce halftone and gradation having a good approximation to desired printed matter.

The second feature of the system developed in the present invention is that the system of the present invention provides a good reproducibility in repetition. Since the heat transfer image thus reproduced has sharp-dots, dots can be faithfully reproduced according to laser light. Further, since the dependence of the recording properties on the ambient temperature and humidity is very small, a stable reproducibility in repetition can be obtained both with color hue and density in a wide temperature and humidity atmosphere.

The third feature of the system developed in the present invention is that the system of the present invention provides a good color reproducibility. The heat transfer image obtained in the system is formed by coloring pigments which are commonly incorporated in printing inks. Further, since this system provides a good reproducibility in repetition, a high precision CMS (color management system) can be realized.

Further, this heat transfer image can have substantially the same color hues as that of Japan Color, SWOP Color, etc., i.e., printed matter. This heat transfer image can also show the same change of visual appreciation of colors as desired printed matter with change of light sources such as fluorescent lamp and incandescent lamp.

The fourth feature of the system developed in the present invention is that the system of the present invention provides a good character quality. The heat transfer image obtained in this system has sharp dots and thus realizes sharp reproduction of fine lines constituting fine characters.

The features of the technique of material of the system of the present invention will be further described hereinafter. Examples of heat transfer process for DDCP include \textcircled{1} sublimation process, \textcircled{2} ablation process, and \textcircled{3} heat melt process. The processes \textcircled{1} and \textcircled{2} involve the sublimation or scattering of coloring material and are disadvantageous in that the resulting dots have a blurred contour. On the other hand, the process \textcircled{3}, too, involves the flow of molten material and thus is disadvantageous in that the resulting dots cannot be provided with a clear contour. We made clear new problems in the laser heat transfer system on the basis of thin film transfer technique and proposed the following technique for higher image quality.

The first feature of the material technique is to sharpen the dot shape. In some detail, laser light is converted to heat in the light-to-heat conversion layer. The heat is then transferred to the image-forming layer to allow the image-forming layer to be bonded to the image-receiving layer. In this manner, image recording is effected. In order to sharpen the dot shape, heat developed by laser light is transferred to the transfer interface without being diffused horizontally so that the image-forming layer undergoes sharp break at the heated portion-unheated portion interface. In this arrangement, the thickness of the light-to-heat conversion layer in the heat transfer sheet can be reduced. Further, the dynamic properties of the image-forming layer can be controlled.

The first technique for sharpening the dot shape is to reduce the thickness of the light-to-heat conversion layer. A simulation of this mechanism shows that the temperature of the light-to-heat conversion layer momentarily reaches about 700° C. Thus, when the thickness of the light-to-heat conversion layer is too small, the light-to-heat conversion layer can easily undergo deformation or fracture. Once deformed or fractured, the light-to-heat conversion layer can be transferred to the image-receiving sheet with the image-forming layer. Other defectives include ununiform transfer image. On the other hand, in order to obtain a predetermined temperature, it is necessary that a photo-heat conversion material be present in the light-to-heat conversion layer in a high concentration, causing the deposition of dyes or the migration of dyes to the adjacent layers. As the photo-heat conversion material there has heretofore been often used carbon black. In the present invention, however, an infrared-absorbing dye, the required amount of which is smaller than that of carbon black, was used. As the binder there was used a polyimide-based compound which has a sufficient dynamic strength and can fairly retain an infrared-absorbing dye therein.

By thus selecting an infrared-absorbing dye having excellent photo-heat conversion properties and a heat-resistant binder such as polyimide-based compound, the thickness of the light-to-heat conversion layer is preferably reduced to about not greater than 0.5 μm.

The second technique for sharpening the dot shape is to improve the properties of the image-forming layer. When the light-to-heat conversion layer undergoes deformation or the image-forming layer itself undergoes deformation when acted upon by high heat, the image-forming layer which has been transferred to the image-receiving layer undergoes unevenness corresponding to pattern of subsidiary scanning of laser light, giving ununiform image and lowering apparent transfer density. This tendency becomes more remarkable as the thickness of the image-forming layer decreases. On the other hand, when the thickness of the image-forming layer increases, the resulting dots have impaired sharpness and the sensitivity is lowered.

In order to meet the two conflicting requirements at the same time, a low melting material such as wax is preferably incorporated in the image-forming layer to eliminate uneven transfer. Alternatively, an inorganic particulate material may be incorporated in the image-forming layer instead of binder to properly increase the thickness of the image-forming layer so that the image-forming layer can undergo sharp break at the heated portion-unheated portion interface, making it possible to eliminate uneven transfer while keeping desired sharpness of dots and sensitivity.

In general, a low melting material such as wax tends to ooze out of the surface of the image-forming layer or undergo crystallization and thus can impair the image quality or the age stability of the heat transfer sheet.

In order to solve this problem, a low melting material having a small difference in Sp value from that of the polymer of the image-forming layer is preferably used. Such a low melting material has a high compatibility with the polymer and thus can be prevented from being separated from the image-forming layer. Alternatively, several kinds of low melting materials having different structures are preferably mixed to prepare a eutectic mixture that prevents crystallization. As a result, an image having sharp dots and little unevenness is obtained.

The second feather of the material technique is the discovery of the fact that the recording sensitivity is dependent on temperature and humidity. In general, when moistened, the coat layer of a heat transfer sheet shows a change of dynamic properties and thermal properties to render the recording conditions dependent on humidity.

In order to eliminate this dependence on temperature and humidity, the dye/binder system of the light-to-heat conversion layer and the binder system of the image-forming layer each are preferably an organic solvent system. As the binder to be incorporated in the image-receiving layer there is preferably used a polyvinyl butyral. At the same time, in order to lower the water absorption of the binder, a polymer hydrophobicizing technique is preferably employed. Examples of such a polymer hydrophobicizing technique include a method involving the reaction of hydroxyl group with hydrophobic group as described in JP-A-8-238858, and a method involving the crosslinking of two or more hydroxyl groups with a hardener.

The third feature of the material technique is that the approximation of color hue to desired printed matter has been improved. In addition to color matching of pigment in color proof (e.g., FirstProof, produced by Fuji Photo Film Co., Ltd.) of thermal head process and technique for stable dispersion, the use of a laser heat transfer system made clear the following new problems. In some detail, the first technique for improving the approximation of color hue to desired printed matter is to use a highly heat-resistant pigment. In general, the image-forming layer, too, is heated to a temperature as high as about 500° C. or higher during printing by laser exposure. Thus, some of pigments which have heretofore been used for this purpose undergo thermal decomposition. This difficulty can be eliminated by using a pigment having a high heat resistance in the image-forming layer.

The second technique for improving the approximation of color hue to desired printed matter is to prevent the diffusion of an infrared-absorbing dye. In order to prevent the infrared-absorbing dye from migrating from the light-to-heat conversion layer to the image-forming layer to cause change of color hue when acted upon by high heat upon printing, the light-to-heat conversion layer is preferably designed by combining an infrared-absorbing dye and a dye having a strong retention as mentioned above.

The fourth feature of the material technique is to enhance sensitivity. In general, energy runs short during high speed printing, causing the occurrence of a gap corresponding to the pitch of subsidiary scanning of laser light. As previously mentioned, the enhancement of the concentration of dye in the light-to-heat conversion layer and the reduction of the thickness of the light-to-heat conversion layer and the image-forming layer make it possible to enhance the efficiency of generation/transmission of heat. Further, for the purpose of allowing the image-forming layer to flow slightly and fill the gap upon heating and enhance the adhesion to the image-receiving layer, the image-forming layer preferably comprises a low melting material incorporated therein. In order to enhance the adhesion between the image-receiving layer and the image-forming layer and hence provide the transferred image with a sufficient strength, as the binder to be incorporated in the image-receiving layer there is preferably used a polyvinyl butyral as in the image-forming layer.

The fifth feature of the material technique is to improve vacuum adhesion. It is preferred that the image-receiving sheet and the heat transfer sheet be retained on a drum by vacuum suction. Vacuum adhesion is important because the formation of an image is carried out by controlling the adhesion between the two sheets and the transfer behavior of image is very sensitive to the clearance between the surface of the image-receiving layer of the image-receiving sheet and the surface of the image-forming layer of the transfer sheet. When the entrance of foreign matters such as dust causes the increase of clearance between the two materials, image defectives or uneven image transfer can occur.

In order to prevent the occurrence of these image defectives or uneven image transfer, the heat transfer sheet is preferably provided with uniform roughness to facilitate the passage of air and hence obtain a uniform clearance.

The first technique for improving vacuum adhesion is to roughen the surface of the heat transfer sheet. In order to exert a sufficient effect of vacuum adhesion even in lap printing of two or more colors, the heat transfer sheet is provided with roughness. The provision of the heat transfer sheet with roughness is normally accomplished by post-treatment such as embossing or the incorporation of a matting agent in the coat layer. In order to simplify the production process or stabilize the age stability of the material, the incorporation of a matting agent in the coat layer is preferred. The matting agent to be used herein needs to be greater than the thickness of the coat layer. When a matting agent is incorporated in the image-forming layer, the resulting image lacks at the area where the matting agent exists. Thus, it is preferred that a matting agent having an optimum particle diameter be incorporated in the light-to-heat conversion layer. In this arrangement, the image-forming layer itself has a substantially uniform thickness, making it possible to obtain an image free of defects on the image-receiving sheet.

The features of the systematizing technique of the system of the present invention will be described hereinafter. The first feature of the systematizing technique is the arrangement of the recording device. In order to assure the realization of sharp dots as mentioned above, the recording device, too, must be designed to a high precision. The basic arrangement of the system of the present invention is similar to that of conventional laser heat transfer recording device. This arrangement forms a so-called heat mode outer drum recording system in which a recording head provide with a plurality of high power lasers emits a laser light to a heat transfer sheet and an image-receiving layer fixed to a drum to effect recording. Among these arrangements, the following embodiment is preferred.

The first arrangement of recording device is to avoid the entrance of dust. The supply of the image-receiving sheet and the heat transfer sheet is carried out by a full automatic roll supply system. The supply of a small number of sheets is carried out by a roll supply system because much dust produced from the human body enters in the recording device. Herein, the rolled image-receiving sheet is wound with surface of the image-receiving layer outside.

A roll is provided for four color heat transfer sheets. A loading unit is rotated to switch among the various color rolls. The various films are each cut into a predetermined length by a cutter during loading, and then fixed to the drum. The second arrangement of recording device is to enhance the adhesion the image-receiving sheet on the recording drum to the heat transfer sheet. The fixing of the image-receiving sheet and the heat transfer sheet to the recording drum is accomplished by vacuum suction. This is because mechanical fixing cannot enhance the adhesion between the image-receiving sheet and the heat transfer sheet. The recording drum has a number of vacuum suction holes formed on the surface thereof such that the sheet is sucked by the drum when the pressure in the interior of the drum is reduced by a blower or vacuum pump. Since the heat transfer sheet is sucked by the image-receiving sheet which has been sucked by the drum, the heat transfer sheet is designed to have a greater size than the image-receiving sheet. The air occurring between the heat transfer sheet and the image-receiving sheet which has the greatest effect on the recording properties comes only from the area of the heat transfer sheet outside the image-receiving sheet.

The third arrangement of recording device is to pile up a plurality of sheets on the receiving tray in a stable manner. In the present recording device, a number of sheets having an area as large as B2 size or more can be piled up on the receiving tray. When a sheet B is outputted onto the image-receiving layer of a thermal adhesive film A which has been outputted on the receiving tray, the two sheets can be stuck to each other. This trouble prevents the subsequent sheet from being completely outputted onto the receiving tray, causing jamming. Sticking can be best prevented by preventing the films A and B from being in contact with each other. Several methods for preventing contact are known. Examples of these methods include (a) method which comprises providing the receiving tray with a difference in level so that the film outputted thereonto is not flat to make a gap between the films, (b) structure in which the outlet port is provided higher than the receiving tray so that the outputted film drops onto the receiving tray, and (c) method which comprises blowing air into the gap between the two films so that the upper film is floated up. In this system, since the maximum allowable sheet size is as very large as B2, the air blowing method (c) is employed rather than the methods (a) and (b), which require a very large structure. Accordingly, the method which comprises blowing air into the gap between the two films so that the upper film is floated up is employed herein.

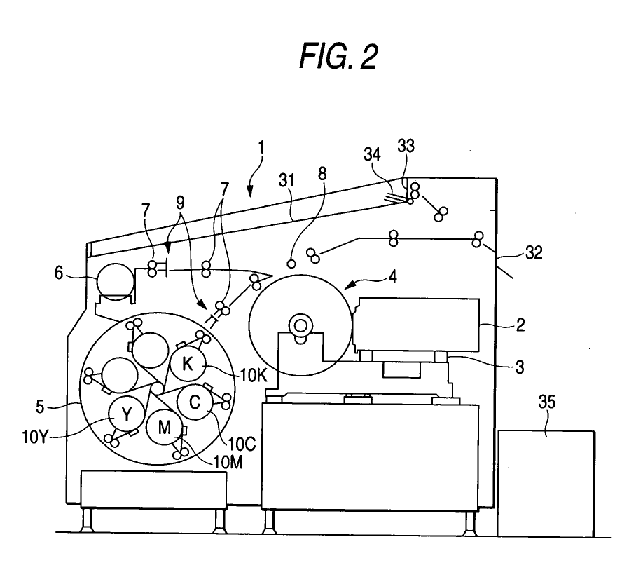

An example of the structure of the device of the present invention will be shown in FIG. 2.

A sequence for the formation of a full-color image using an image-forming material in the foregoing device (hereinafter referred to as “image-forming sequence of the system of the present invention”) will be described hereinafter.
1) The subsidiary scanning axis of a recording head 2 of a recording device 1 returns to the original point along the subsidiary scanning rail 3. Further, the main scanning rotary axis of a recording drum 4 and a heat transfer sheet loading unit 5 return to the original point.
2) An image-receiving roll 6 is unwound by a conveyance roller 7, and then vacuum-sucked by the recording drum 4 at the forward end thereof through suction holes formed in the recording drum 4 so that it is fixed to the recording drum 4.
3) A squeeze roller 8 then comes down onto the recording drum 4. While being pressed by the squeeze roller 8, the recording drum 4 rotates until the image-receiving sheet is transported by a predetermined length at which it is then cut by a cutter.
4) The recording drum 4 then rotates by one turn to complete the loading of the image-receiving sheet.
5) A sequence similar to that of image-receiving sheet is performed so that a first color (black) heat transfer sheet K is drawn out from a heat transfer sheet roll 10K, cut and then charged onto the drum.
6) Subsequently, the recording drum 4 beings to rapidly rotate and the recording head 2 begins to move along the subsidiary scanning rail 3. When the recording head 2 reached the recording starting point, the recording head 2 causes the recording drum 4 to be irradiated with a recording laser light according to a recording image signal. Irradiation ends at the recording termination point and the movement of the recording head 2 and the rotation of the recording drum stop. The recording head on the subsidiary scanning rail is returned to the original point.
7) The heat transfer sheet K alone is peeled off the recording drum leaving the image-receiving sheet behind. To this end, the heat transfer sheet K is caught by a nail at the forward end thereof, and then pulled out of the recording drum in the discharging direction. The heat transfer sheet K is then discharged into a waste box 35 through a waste port 32.
8) The foregoing procedures (5) to (7) are repeated for the remaining three colors. The order of colors to be recorded is black, cyan, magenta and yellow. In some detail, a second color (cyan) heat transfer sheet C, a third color (magenta) heat transfer sheet M and a fourth (color) heat transfer sheet Y are sequentially drawn out of a heat transfer sheet roll 10C, a heat transfer sheet roll 10M and a heat transfer sheet roll 10Y, respectively. This order of printing is reverse to the ordinary printing order. This is because these colors are transferred to final paper in this order at the subsequent step and are reverse order on the final paper.
9) When the procedures for four colors are completed, the image-receiving sheet on which image recording has been made is finally discharged onto the receiving tray 31. In order to peel the image-receiving sheet off the recording drum, the same method as used in the procedure (7) may be used. However, since the image-receiving sheet is not discarded unlike the heat transfer sheet, the image-receiving sheet is turned at the waste port 32 toward the receiving tray 31 by a switchback mechanism. The image-receiving sheet which is being outputted onto the receiving tray 31 is blown by air 34 from below through a discharge port 33 so that a plurality of image-receiving sheets can be piled up without any trouble.

As any of conveyance rollers 7 to be provided either at a section where the heat transfer sheet is fed or transported, or at a section where the image-receiving sheet is fed or transported, a pressure-sensitive adhesive roll having a surface, the surface comprising a pressure-sensitive material, preferably is used.

The provision of such an adhesive roller makes it possible to clean the heat transfer sheet and the image-receiving sheet.

Examples of the pressure-sensitive adhesive material to be provided on the surface of the pressure-sensitive adhesive adhesive roller include ethylene-vinyl acetate copolymer, ethylene-ethyl acrylate copolymer, polyolefin resin, polybutadiene resin, styrene-butadiene copolymer (SBR), styrene-ethylene-butene-styrene copolymer (SEBS), acrylonitrile-butadiene copolymer (NBR), polyisoprene resin (IR), styrene-isoprene copolymer (SIS), acrylic acid ester copolymer, polyester resin, polyurethane resin, acrylic resin, butyl rubber, polynorbornene, etc.

The pressure-sensitive adhesive roller comes in contact with the surface of the heat transfer sheet and the image-receiving sheet to clean them. The required contact pressure is not specifically limited so far as the pressure-sensitive adhesive roller comes in contact with the surface of the heat transfer sheet and the image-receiving sheet.

The pressure-sensitive adhesive material to be used in the pressure-sensitive adhesive roller preferably has a Vickers hardness Hv of not greater than 50 kg/mm² (approximately equal to 490 MPa) to fully remove dust as foreign matter and hence inhibit the occurrence of image defects.

Vickers hardness is defined by the hardness value determined on a specimen under a static load of a pyramid diamond indenter having an angle of 136° between the opposite faces. Vickers hardness Hv can be determined by the following equation:
Hardness Hv=1.854 P/d²(kg/mm²)(approximately equal to 18.1692 P/d²(MPa)
wherein P is the magnitude of load (Kg); and d is the length of diagonal line of the square of indentation (mm).

In the present invention, the pressure-sensitive adhesive material to be used in the pressure-sensitive adhesive roller preferably exhibits an elastic modulus of 200 kg/cm² (approximately equal to 19.6 MPa) at 20° C. to fully remove dust as foreign matter and hence inhibit the occurrence of image defects as mentioned above.

The second feature of the systematizing technique is an arrangement of heat transferring device.

In order to effect a step of transferring the image-receiving sheet on which an image has been printed by the recording device onto final printing paper (herein referred to as “final paper”), a heat transferring device is used. This step is quite the same as First Proof™. When heat and pressure are applied to a laminate of the image-receiving sheet and the final paper, the two sheets are bonded to each other. Thereafter, when the image-receiving film is peeled off the final paper, the support of the image-receiving sheet and the cushioning layer are removed leaving only the image and the adhesive layer behind on the final paper. Accordingly, the image is practically transferred from the image-receiving sheet to the final paper.

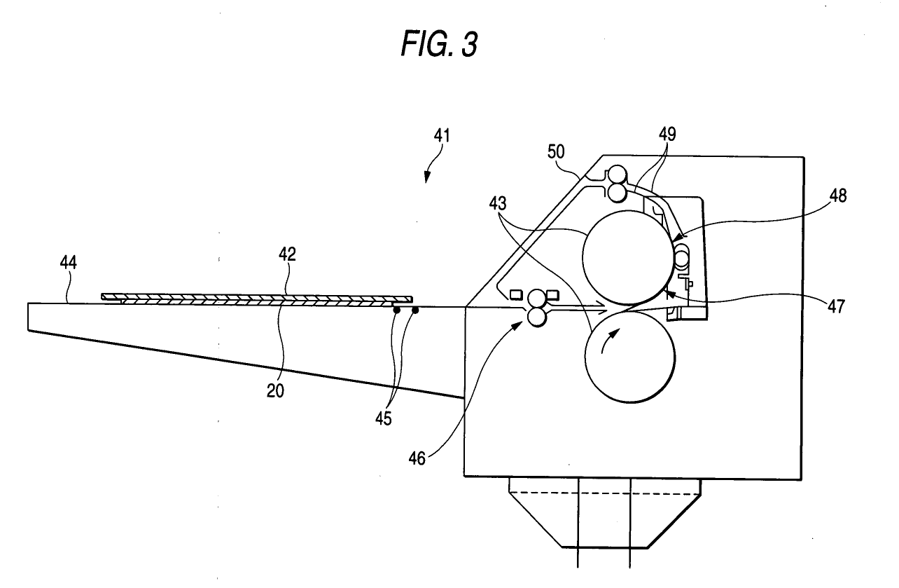

In First Proof™, the final paper and the image-receiving sheet are laminated on an aluminum guide plate. The laminate is then passed through the gap between heat rollers to effect transfer. The purpose of using such an aluminum guide plate is to prevent the deformation of the final paper. However, when First Proof™ is employed in the system of the present invention, which allows image recording on B2 size paper at maximum, an aluminum guide plate having a size of greater than B2 is needed, requiring a larger facility installation space. Accordingly, the system of the present invention employs a structure allowing the rotation of the conveying path by 180° so that the final printing paper is discharged toward the supply side instead of aluminum guide plate. In this arrangement, the required installation space is reduced (FIG. 3). However, since no aluminum guide plate is used, a problem arose that the final paper is deformed. In some detail, the pair of final paper and image-receiving sheet discharged is curled with the image-receiving sheet inside and rolls over on the receiving tray. It is a very difficult job to peel the image-receiving sheet off the curled final paper.

To work out a method for preventing curling, a bimetal effect developed by the difference in shrinkage between the final paper and the image-receiving sheet and an iron effect developed by the structure for winging on a heat roller should be taken into account. In the case where the image-receiving sheet is inserted while being laminated on the final paper as in the conventional process, the thermal shrinkage of the image-receiving sheet in the direction of insertion is greater than that of the final paper, and therefore, the bimetal effect causes the laminate to be curled with the upper sheet inside. This curling occurs in the same direction as that developed by the iron effect, and the resulting synergistic effect adds to curling effect. However, when the image-receiving sheet is inserted while being disposed under the final paper, downward curling developed by the bimetal effect and upward curling developed by the iron effect are compensated each other to advantage.

The sequence for image transfer to final paper (hereinafter referred to as “process for image transfer to final paper used in the system of the present invention”) will be described hereinafter. A heat transfer device 41 shown in FIG. 3 used in this process is a device requiring manual job unlike the recording device.
1) Firstly, the heat roller 43 having a diameter of from 50 to 350 mm, preferably from 70 to 150 mm (heated to a temperature of from 80° C. to 250° C., preferably from 100° C. to 110° C.) and the conveying speed during transfer are predetermined by dialing (not shown) according to the kind of final paper.
2) Subsequently, the image-receiving sheet 20 is disposed on the inserting tray with the image side facing upward. Dust is then removed from the image with a destaticizing brush (not shown). The final paper 42 from which dust has been removed is then imposed on the image-receiving sheet 20. Since the final paper 42 which is disposed above the image-receiving film 20 is grater in size than the image-receiving film 20, the position of the image-receiving sheet 20 cannot be seen, making it difficult to register the two sheets. In order to improve the efficiency of this job, the insertion tray 44 is provided with marks 45 indicating the predetermined position of the image-receiving sheet and the final paper, respectively. The reason why the final paper is larger than the image-receiving sheet is to prevent the image-receiving sheet from being displaced from the final paper 42 to stain the heat roller 43 with the image-receiving layer.
3) When the laminate of the image-receiving sheet and the final paper is pushed into the insertion port, an insertion roller 46 then rotates to convey the two sheets toward the heat roller 43.
4) When the forward end of the final paper reaches the heat roller 43, the final paper is nipped by the pair of heat rollers 43 to begin image transfer. The heat roller is a heat-resistant silicone rubber roller. When heat and pressure are simultaneously applied to the laminate, the image-receiving sheet and the final paper are bonded to each other. There is provided a guide 47, made of a heat resistance sheet, downstream from the heat rollers. The laminate of image-receiving sheet and final printing paper is then conveyed upward through the gap between the upper heat roller and the guide 47 while being heated. The laminate is then peeled off the heat roller at a peeling nail 48. The laminate is then introduced to a discharge port 50 along a guide plate 49.
5) The image-receiving sheet and the final paper which have been discharged from the discharge port 50 are discharged onto the insertion tray while being still laminated. Thereafter, the image-receiving sheet 20 is manually peeled of the final paper 42.

The third feature of the systematizing technique is an arrangement of the system.

By connecting the foregoing device to a plate-making system, a function of color proof can be performed. This system needs to output from the proof a printed matter having an image quality infinitely close to that of a printed matter outputted from a plate-making data. To this end, a soft ware for approximating the color and halftone of the output to that of printed matter is required. Specific examples of connection of the foregoing device to a plate-making system will be given below.

In the case where a proof of printed matter from a plate-making system called “Celebra™” (produced by Fuji Photo Film Co., Ltd.) is required, the following system connection is employed. To Celebra is connected a CTP (Computer to Plate) system. The printing plate thus outputted can then be mounted on a printing machine to obtain a final printed matter. To Celebra is connected Luxel FINALPROOF 5600 (hereinafter referred also to as “FINALPROOF”) (produced by Fuji Photo Film Co., Ltd.) as the foregoing recording device. PD (produced by Fuji Photo Film Co., Ltd.) is provided in between Celebra and FINALPROOF for approximating the color and halftone of color to that of desired printed matter.

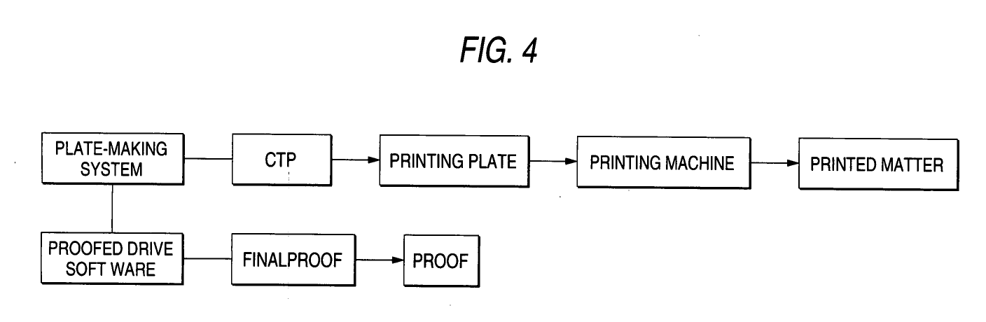

The continuous tone data which has been converted to raster data at Celebra is then converted to a binary data for halftone which is then outputted to a CTP system by which it is finally printed. On the other hand, the continuous tone data is also outputted to the PD system. The PD system then converts the data received such that their colors coincide with that of the printed matter according to a four-dimensional (black, cyan, magenta, yellow) table. The data is finally converted to a binary data for halftone so as to coincide with the halftone of the desired printed matter, and then outputted to FINALPROOF (FIG. 4).

The four-dimensional table has previously been experimentally prepared, and then stored in the system. The experiment for preparation is as follows. In some detail, an important color data is printed via a CTP system to prepare an image. On the other hand, the important color data is outputted to FINALPROOF via a PD system to prepare another image. The colorimetry value of the two images are then measured and compared. The four-dimensional table is then prepared such that the difference in colorimetry value between the two images is minimum.

As mentioned above, the present invention realized a system arrangement allowing full performance of the function of a material having a high resolving power.

The heat transfer sheet as a material to be used in the system of the present invention will be described hereinafter.

It is preferred that the absolute value of the difference between the surface roughness Rz of the surface of the image-forming layer of the heat transfer sheet and the surface roughness of the back surface of the image-forming layer be not greater than 3.0 and the absolute value of the difference between the surface roughness Rz of the surface of the image-receiving layer of the heat transfer sheet and the surface roughness of the back surface of the image-receiving layer be not greater than 3.0. This arrangement, combined with the action of the foregoing cleaning unit, can prevent the occurrence of image defects, eliminate jamming during conveyance and improve dot gain stability.

From the standpoint of further enhancement of the foregoing effect, it is preferred that the absolute value of the difference between the surface roughness Rz of the surface of the image-forming layer of the heat transfer sheet and the surface roughness of the back surface of the image-forming layer be not greater than 1.0 and the absolute value of the difference between the surface roughness Rz of the surface of the image-receiving layer of the heat transfer sheet and the surface roughness of the back surface of the image-receiving layer be not greater than 1.0.

The gloss of the image-forming layer of the heat transfer sheet is preferably from 80 to 99.

The gloss of the image-forming layer greatly depends on the surface smoothness of the image-forming layer, which affects the uniformity in the thickness of the image-forming layer. The greater the gloss of the image-forming layer is, the more uniform is the thickness of the image-forming layer and the more suitable for the purpose of high precision image is the heat transfer sheet. However, as the smoothness of the image-forming layer increases, the resistance in conveyance increases and the two factors are trade-off factors. When the gloss of the image-forming layer is from 80 to 99, the two requirements can be met at the same time and well balanced.

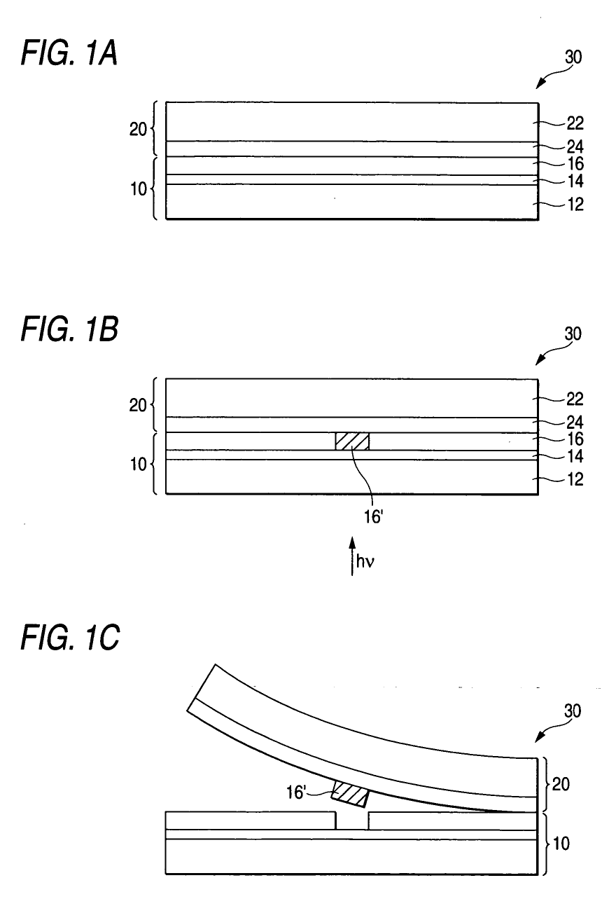

The outline of the mechanism of forming a multi-color image by a thin film heat transfer using laser will be described hereinafter in connection with FIG. 1.

An image-forming laminate 30 having an image-receiving sheet 20 laminated on the surface of an image-receiving layer 16 containing a black (K), cyan (C), magenta (M) or yellow pigment in a heat transfer sheet 10 is prepared. The heat transfer sheet 10 comprises a support 12, a light-to-heat conversion layer 14 provided on the support 12, and an image-receiving layer 16 provided on the light-to-heat conversion layer 14. The image-receiving sheet 20 comprises a support 22, and an image-receiving layer 24 provided on the support 22. The heat transfer sheet 10 and the image-receiving sheet 20 are laminated in such an arrangement that the image-forming layer 16 and the image-receiving layer 24 come in contact with each other (FIG. 1A). When the laminate 30 is sequentially imagewise irradiated with laser light on the support 12 of the heat transfer sheet 10, the laser light-irradiated area of the light-to-heat conversion layer 14 of the heat transfer sheet 10 generates heat to lower the adhesion of the light-to-heat conversion layer 14 to the image-forming layer 16 (FIG. 1B). Thereafter, when the image-receiving sheet and the heat transfer sheet 10 are peeled off each other, the laser light-irradiated area 16′ of the image-forming layer 16 is transferred to the image-receiving layer 24 of the image-receiving sheet 20 (FIG. 1C).

In the formation of a multi-color image, the laser light to be used in irradiation is preferably a multi-beam, particularly a binary arrangement of multi-beams. The term “binary arrangement of multi-beams” as used herein is meant to indicate that recording by irradiation with laser light is carried out by the use of a plurality of laser lights and the spot arrangement of these laser beams forms a binary plane arrangement consisting of a plurality of lines in the direction of main scanning and a plurality of rows in the direction of subsidiary scanning.

By using a laser light in a binary arrangement, the time required for laser recording can be reduced.

The laser light for this purpose is not specifically limited, and for example, a gas laser light such as argon ion laser light, helium neon laser light and helium cadmium laser light, solid laser light such as YAG laser light or a direct laser light such as semiconductor laser light, dye laser light and exima laser light may be used. Alternatively, a light beam obtained by passing such a laser light through a second harmonic element to halve the wavelength thereof may be used. In the formation of a multi-color image, a semiconductor laser light is preferably used taking into account the output power or modulatability. In the formation of a multi-color image, the laser light is preferably emitted in such an arrangement that the diameter of beam spot on the light-to-heat conversion layer is from 5 μm to 50 μm (particularly from 6 μm to 30 μm), and the scanning speed is preferably 1 m/sec or more (particularly 3 m/sec or more).

In the formation of a multi-color image, it is preferred that the thickness of the image-forming layer of the black heat transfer sheet be greater than that of the image-forming layer of the yellow, magenta and cyan heat transfer sheets and be from 0.5 μm to 0.7 μm. In this arrangement, when the black heat transfer sheet is irradiated with laser light, the reduction of density due to uneven transfer can be inhibited.

In accordance with the foregoing arrangement that the thickness of the image-forming layer of the black heat transfer sheet is not smaller than 0.5 μm, a high energy recording can be effected without uneven transfer to maintain desired image density, making it possible to attain an image density required for print proof. Since this tendency becomes more remarkable under high temperature and humidity conditions, the density change due to environmental factor can be inhibited. On the other hand, by the predetermining the thickness of the image-forming layer of the black heat transfer sheet to not greater than 0.7 μm, desired transfer sensitivity can be maintained during laser recording, facilitating printing of small points and fine lines. This tendency becomes more remarkable under low temperature and humidity conditions. Further, the resolving power can be enhanced. The thickness of the image-forming layer of the black heat transfer sheet is more preferably from 0.55 μm to 0.65 μm, particularly 0.60 μm.

Further, it is preferred that the thickness of the image-forming layer in the foregoing black heat transfer sheet be from 0.5 μm to 0.7 μm and the thickness of the image-forming layer in the foregoing yellow, magenta and cyan heat transfer sheets be from not smaller than 0.2 μm to less than 0.5 μm.

By predetermining the thickness of the image-forming layer in the foregoing yellow, magenta and cyan heat transfer sheets to not smaller than 0.2 μm, laser recording can be effected free from uneven transfer to maintain desired density. On the contrary, by predetermining the thickness of the image-forming layer in the foregoing yellow, magenta and cyan heat transfer sheets to not greater than 0.5 μm, the transfer sensitivity or resolution can be improved. More preferably, it is from 0.3 μm to 0.45 μm.

The image-forming layer in the foregoing black heat transfer sheet preferably comprises carbon black incorporated therein. The carbon black preferably consists of at least two carbon blacks having different coloring powers to adjust properly the reflection density while keeping P/B (pigment/binder) ratio constant.

The coloring power of carbon black can be represented by various methods. For example, PVC blackness as disclosed in JP-A-10-140033 may be employed. For the definition of PVC blackness, carbon black is added to a PVC resin. The PVC resin is then subjected to dispersion and formation into sheet through a twin roll. The blackness of Carbon Black #40 and #45 (produced by Mitsubishi Chemical Corporation) are defined to be 1 and 10, respectively, as reference. The blackness of samples are each visually judged on the basis of these reference values. Two or more carbon blacks having different PVC blacknesses may be properly selected and used depending on the purpose.

A specific example of the process for the preparation of sample will be described hereinafter.

<Process for the Preparation of Sample>

ALDPE (low density polyethylene) resin and a sample carbon black in an amount of 40% by weight are blended and kneaded at a temperature of 115° C. for 4 minutes in a 250 cc Banbury mixer.

Blending Conditions:

| | | |
|---|---|---|
| LDPE resin | 101.89 | g |
| Calcium stearate | 1.39 | g |
| Irganox 1010 | 0.87 | g |
| Sample carbon black | 69.43 | g |

Subsequently, the mixture is diluted at 120° C. by means of a twin-roll mill such that the carbon black concentration reaches 1% by weight.

Conditions for the Preparation of Diluted Compound:

| | | |
|---|---|---|
| LDPE resin | 58.3 | g |
| Calcium stearate | 0.2 | g |
| Resin having 40% by weight of | 1.5 | g |
| carbon black incorporated | | |
| therein | | |

The diluted compound thus obtained is then extruded through a slit having a width of 0.3 mm to form a sheet, and the sheet thus formed is cut into chips on a hot plate at 240° C. to form a film having a thickness of 65±3 μm.

The formation of a multi-color image can be accomplished by a process which comprises imposing a number of image layers (image-forming layer having an image formed thereon) on the same image-receiving sheet one after another using the foregoing heat transfer sheet as mentioned above, and alternatively, a multi-color image may be formed by a process which comprises forming an image on the image-receiving layer of a plurality of image-receiving sheets, and then transferring the images to the final printing paper.

Referring to the latter process, heat transfer sheets having an image-forming layer comprising coloring materials having different color hues are prepared, and four laminates of such a heat transfer sheet with an image-receiving sheet (four colors: cyan, magenta, yellow, black) are independently prepared. These laminates are each then irradiated with laser light according to digital signal based on the image through a color separation filter, and subsequently, the heat transfer sheet and the image-receiving sheet are peeled off each other so that color separation images are independently formed on the respective image-receiving sheet. These color separation images are then sequentially laminated on an actual support such as final printing paper separately prepared or analogue to form a multi-color image.

In any case, the resolution of the image transferred from the image-forming layer of the heat-transfer sheet to the image-receiving layer of the image-receiving sheet can be predetermined to be 2,400 dpi or more, preferably 2,500 dpi or more.

The heat transfer sheet to be irradiated with laser light is preferably adapted to convert laser light to heat energy by which an image-forming layer containing a pigment is transferred to the image-receiving sheet by a thin film transfer process to form an image on the image-receiving sheet, and the technique used to develop the image-forming material comprising such a heat transfer sheet and image-receiving sheet can be properly applied to the development of heat transfer sheet and/or image-receiving sheet of melting transfer process, ablation transfer process, sublimation transfer process, etc., and the system of the present invention may include image-forming materials for use in these processes.

The heat transfer sheet and image-receiving sheet will be further described hereinafter.

[Heat Transfer Sheet]

The heat transfer sheet comprises at least a light-to-heat conversion layer and an image-forming layer and optionally other layers provided on a support.

(Support)

The material constituting the support of the heat transfer sheet is not specifically limited, and various support materials may be used depending on the purpose. The support material preferably is rigid, dimensionally stable and resistant to heat developed upon the formation of image. Preferred examples of the support material include synthetic resin materials such as polyethylene terephthalate, polyethylene-2,6-naphthalate, polycarbonate, polymethyl methacrylate, polyethylene, polypropylene, polyvinyl chloride, polyvinylidene chloride, polystyrene, styrene-acrylonitrile copolymer, polyamide (aromatic or aliphatic), polyimide, polyamideimide and polysulfone. In particular, a biaxially oriented polyethylene terephthalate is preferred taking into account its mechanical strength or dimensional stability to heat. In the case where the present invention is used to prepare a color proof utilizing laser recording, the support of the heat transfer sheet is preferably formed by a transparent synthetic resin which transmits laser light. The thickness of the support is preferably from 25 μm to 130 μm, particularly from 50 μm to 120 μm. The support preferably has a central line average surface roughness Ra (measured by means of a surface roughness meter (Surfcom, produced by TOKYO SEIKI CO., LTD.) according to JIS B0601) of less than 0.1 μm on the image-forming layer side thereof. The support preferably exhibits a Young's modulus of from 200 to 1,200 Kg/mm² (approximately equal to 2 to 12 GPa) in the longitudinal direction and from 250 to 1,600 Kg/mm² (approximately equal to 2.5 to 16 GPa) in the crosswise direction. The support preferably exhibits an F-5 value of from 5 to 50 Kg/mm² (approximately equal to 49 to 490 MPa) in the longitudinal direction and from 3 to 30 Kg/mm² (approximately equal to 29.4 to 294 MPa) in the crosswise direction. It is usual that the support exhibits a higher F-5 value in the longitudinal direction than in the crosswise direction unless in the case where the crosswise strength needs to be enhanced. The percent thermal shrinkage of the support in the longitudinal direction and crosswise direction is preferably not greater than 3%, more preferably not greater than 1.5% after 30 minutes of heating to 100° C., or preferably not greater than 1%, more preferably not greater than 0.5% after 30 minutes of heating to 80° C. The support preferably exhibits a breaking strength of from 5 to 100 Kg/mm² (approximately equal to 49 to 980 MPa) in both the longitudinal and crosswise directions and an elastic modulus of from 100 to 2,000 Kg/mm² (approximately equal to 0.98 to 19.6 GPa).

The support of the heat transfer sheet may be subjected to surface activation treatment and/or provided with one or more undercoating layers to improve the adhesion to the light-to-heat conversion layer provided thereon. Examples of the surface activation treatment include glow discharge treatment, corona discharge treatment, etc. As the material constituting the undercoating layer there is preferably used one having a high adhesion to both the surface of the support and the light-to-heat conversion layer, a small heat conductivity and an excellent heat resistance. Examples of the material of the undercoating layer include styrene, styrene-butadiene copolymer, and gelatin. The total thickness of the undercoating layers is normally from 0.01 μm to 2 μm. If necessary, the heat transfer sheet may be provided with various functional layers such as anti-reflection layer and anti static layer or subjected to surface treatment on the surface thereof opposite the light-to-heat conversion layer.

(Back Layer)

The heat transfer sheet of the present invention preferably comprises a back layer provided on the surface thereof opposite the light-to-heat conversion layer. The back layer preferably consists of two layers, i.e., 1st back layer adjacent to the support and 2nd back layer provided on the side of the support opposite the 1st back layer. In the present invention, the ratio (B/A) of the mass A of the antistat contained in the 1st back layer to the mass B of the antistat contained in the 2nd back layer is preferably less than 0.3. When B/A is not smaller than 0.3, the resulting back layer tends to exhibit deteriorated slipperiness and be more subject to powder falling.

The thickness C of the 1st back layer is preferably from 0.01 μm to 1 μm, more preferably from 0.01 μm to 0.2 μm. The thickness D of the 2nd back layer is preferably from 0.01 μm to 1 μm, more preferably from 0.01 μm to 0.2 μm. The ratio of the thickness C of the 1st back layer to the thickness D of the 2nd back layer (C:D) is preferably 1:2 to 5:1.

Examples of the antistat to be incorporated in the 1st and 2nd back layers include nonionic surface active agents such as polyoxyethylene alkylamine and glycerinaliphatic acid ester, cationic surface active agents such as quaternary ammonium salt, anionic surface active agents such as alkyl phosphate, amphoteric surface active agents, and compounds such as electrically-conductive resin.

An electrically-conductive particulate material may be used also as an antistat. Examples of such an electrically-conductive particulate material include oxides such as ZnO, TiO₂, SnO₂, Al₂O₃, In₂O₃, MgO, BaO, CoO, CuO, Cu₂O, CaO, SrO, BaO₂, PbO, PbO₂, MnO₃, MoO₃, SiO₂, ZrO₂, Ag₂O, Y₂O₃, Bi₂O₃, Ti₂O₃, Sb₂O₃, Sb₂O₅, K₂Ti₆O₁₃, NaCaP₂O₁₈ and MgB₂O₅, sulfides such as CuS and ZnS, carbides such as SiC, TiC, ZrC, VC, NbC, MoC and WC, nitrides such as Si₃N₄, TiN, ZrN, VN, NbN and Cr₂N, borides such as TiB₂, ZrB₂, NbB₂, TaB₂, CrB, MoB, WB and LaB₅, silicides such as TiSi₂, ZrSi₂, NbSi₂, TaSi₂, CrSi₂, MoSi₂ and WSi₂, metal salts such as BaCO₃, CaCO₃, SrCO₃, BaSO₄ and CaSO₄, and composites such as SiN₄—SiC and 9Al₂O₃-2B₂O₃. These materials may be used singly or in combination of two or more thereof. Preferred among these materials are SnO₂, ZnO, Al₂O₃, TiO₂, In₂O₃, MgO, BaO and MoO₃. Even more desirable among these materials are SnO₂, ZnO, In₂O₃ and TiO₂. Particularly preferred among these materials is SnO₂.

In the case where the heat transfer material of the present invention is used in the laser heat transfer recording process, the antistat to be used in the back layer is preferably substantially transparent so that laser light can be transmitted thereby.

In the case where the electrically-conductive metal oxide is used as an antistat, the particle diameter of the electrically-conductive metal oxide is preferably as small as possible to minimize light scattering, and the particle diameter of the electrically-conductive metal oxide should be determined according to the ratio of refractive index of particle and binder as a parameter and Mie's theory can be used to determine the optimum particle diameter of the electrically-conductive metal oxide. The particle diameter of the electrically-conductive metal oxide is normally from 0.001 μm to 0.5 μm, preferably from 0.003 μm to 0.2 μm. The term “average particle diameter” as used herein is meant to indicate not only primary particle diameter of electrically-conductive metal oxide but also particle diameter of particles having a high order structure.

The 1st and 2nd back layers may comprise various additives such as surface active agent, lubricant and matting agent or a binder incorporated therein besides the antistat. The amount of the antistat to be incorporated in the 1st back layer is preferably from 10 to 1,000 parts by weight, more preferably from 200 to 800 parts by weight based on 100 parts by weight of the binder. The amount of the antistat to be incorporated in the 2nd back layer is preferably from 0 to 300 parts by weight, more preferably from 0 to 100 parts by weight based on 100 parts by weight of the binder.

Examples of the binder to be used in the formation of the 1st and 2nd back layers include homopolymer and copolymer of acrylic acid monomer such as acrylic acid, methacrylic acid, acrylic acid ester and methacrylic acid ester, cellulose-based polymer such as nitrocellulose, methyl cellulose, ethyl cellulose and cellulose acetate, vinyl polymer and copolymer of vinyl compound such as polyethylene, polypropylene, polystyrene, vinyl chloride-based copolymer, vinyl chloride-vinyl acetate copolymer, polyvinyl pyrrolidone, polyvinyl butyral and polyvinyl alcohol, condensed polymer such as polyester, polyurethane and polyamide, rubber-based thermoplastic polymer such as butadiene-styrene copolymer, polymer obtained by the polymerization or crosslinking of a photo-polymerizable or heat-polymerizable compound such as epoxy compound, and melamine compound.

(Light-To-Heat Conversion Layer)

The light-to-heat conversion layer comprises a photo-heat conversion material, a binder and optionally a matting agent incorporated therein. The light-to-heat conversion layer further comprises other components incorporated therein as necessary.

The photo-heat conversion material is a material capable of converting incident light energy to heat energy. The photo-heat conversion material is normally a dye (the term “dye” is hereinafter referred to as “pigment”) capable of absorbing laser light. In the case where infrared laser is used to effect image recording, an infrared-absorbing dye is preferably used as a photo-heat conversion material. Examples of such a dye include black pigments such as carbon black, macrocyclic compound pigments having absorption in the range of from visible light to near infrared such as phthalocyanine and naphthalocyanine, organic dyes used as laser-absorbing material for high density laser recording on optical disk, etc. (e.g., cyanine dye such as indolenine dye, anthraquinone dye, azulene dye, phthalocyanine dye), and organic metal compound dyes such as dithiol-nickel complex. Among these dyes, the cyanine dye exhibits a high absorption factor with respect to light in the infrared range. Thus, when the cyanine dye is used as a photo-heat conversion material, the thickness of the light-to-heat conversion layer can be reduced, resulting in further enhancement of the recording sensitivity of the heat transfer sheet to advantage.

As the photo-heat conversion material there may be used an inorganic material such as particulate metal material (e.g., blacked silver) besides these dyes.

As the binder to be incorporated in the light-to-heat conversion layer there is preferably used a resin having at least a strength high enough to form a layer on the support and a thermal conductivity. More preferably, the resin is heat-resistant enough to undergo no decomposition due to heat produced from the photo-heat conversion material because it can maintain desired surface smoothness of the light-to-heat conversion layer even after irradiation with high energy light. In some detail, the resin preferably exhibits a thermal decomposition temperature (temperature at which the material shows a 5% mass drop in an air stream at a temperature rising rate of 10° C./min according to TGA process (thermogravimetric analysis)) of not lower than 400° C., more preferably not lower than 500° C.

Further, the binder preferably exhibits a glass transition temperature of from 200° C. to 400° C., more preferably from 250° C. to 350° C. When the glass transition temperature of the binder falls below 200° C., the resulting image can be fogged, and when the glass transition temperature of the binder exceeds 400° C., the solubility of the resin lowers, occasionally deteriorating the production efficiency.

The heat resistance (e.g., thermal deformation temperature or thermal decomposition temperature) of the binder to be incorporated in the light-to-heat conversion layer is preferably higher than that of the materials to be used in other layers provided on the light-to-heat conversion layer.

Specific examples of the binder employable herein include acrylic resins such as methyl polymethacrylate, vinyl resins such as polycarbonate, polystyrene, vinyl chloride-vinyl acetate copolymer and polyvinyl alcohol, polyvinyl butyral, polyester, polyvinyl chloride, polyamide, polyimide, polyetherimide, polysulfone, polyether sulfone, aramide, polyurethane, epoxy resin, and urea/melamine resin. Preferred among these materials is polyimide resin.

In particular, polyimide resins represented by the following general formulae (I) to (VII) are soluble in an organic solvent, and these polyamide resins are preferably used to enhance the productivity of heat transfer sheet. These polyamide resins are preferred also because they improve the viscosity stability, storage properties and humidity resistance of the light-to-heat conversion layer coating solution.

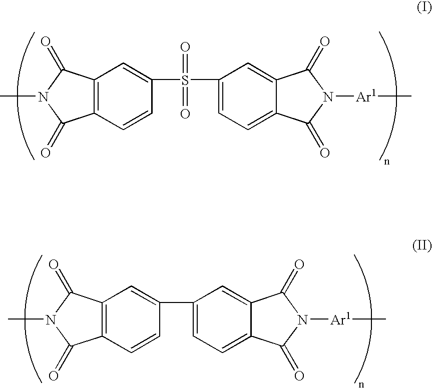

In the aforesaid general formulae (I) and (II), Ar¹ represents an aromatic group represented by the following structural formula (1), (2) or (3); and n represents an integer of from 10 to 100.

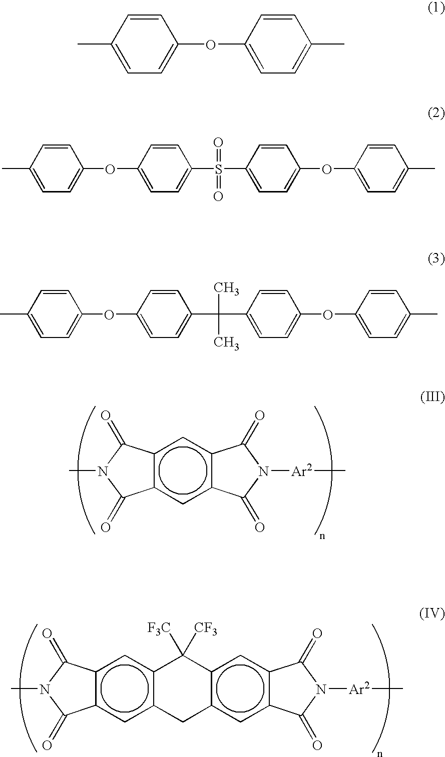

In the aforesaid general formulae (III) and (IV), Ar² represents an aromatic group represented by the following structural formula (4), (5), (6) or (7); and n represents an integer of from 10 to 100.

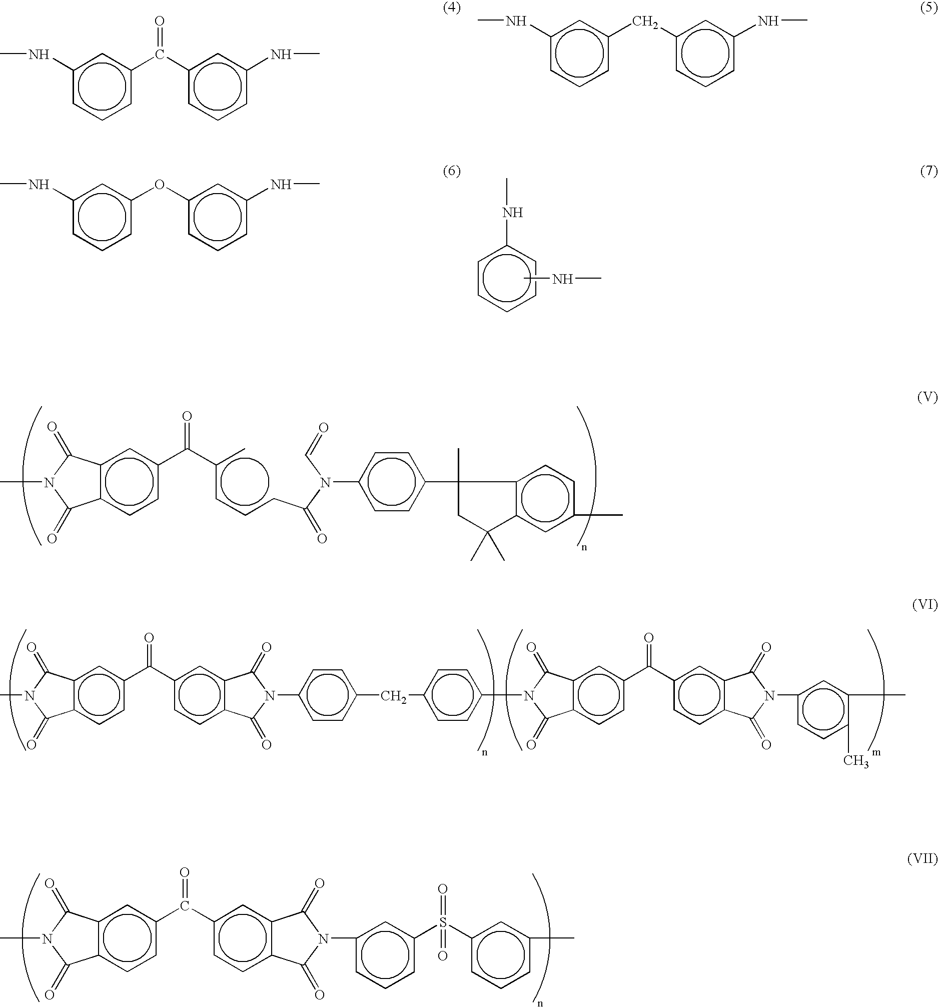

In the general formulae (V) to (VII), n and m each represent an integer of from 10 to 100. In the general formula (VI), the ratio of n:m is from 6:4 to 9:1.

The measure of whether or not the resin is soluble in an organic solvent is whether or not the resin can be dissolved in N-methylpyrrolidone at 25° C. in an amount of 10 parts or more by weight based on 100 parts of N-methylpyrrolidone. A resin which can be dissolved in N-methylpyrrolidone in an amount of 10 parts or more by weight can be preferably used as a resin for light-to-heat conversion layer. More preferably, the resin is dissolved in N-methylpyrrolidone in an amount of 100 parts or more by weight based on 100 parts by weight of N-methylpyrrolidone.

As the matting agent to be incorporated in the light-to-heat conversion layer there may be used an inorganic or organic particulate material. Examples of the inorganic particulate material include silica, metal salt such as titanium oxide, aluminum oxide, zinc oxide, magnesium oxide, barium oxide, magnesium sulfate, aluminum hydroxide, magnesium hydroxide and boron nitride, kaolin, clay, talc, zinc white, white lead, zeeklite, quartz, diatomaceous earth, pearlite, bentonite, mica, and synthetic mica. Examples of the organic particulate material include particulate resin such as particulate fluororesin, particulate guanamine resin, particulate acrylic resin, particulate styrene-acryl copolymer resin, particulate silicone resin, particulate melamine resin and particulate epoxy resin.

The particle diameter of the matting agent is normally from 0.3 μm to 30 μm, preferably from 0.5 μm to 20 μm, and the amount of the matting agent to be incorporated is preferably from 0.1 to 100 mg/m².

The light-to-heat conversion layer may further comprise a surface active agent, a thickening agent, an antistat, etc., incorporated therein as necessary.

The light-to-heat conversion layer can be provided by a process which comprises dissolving a photo-heat conversion material and a binder, optionally adding a matting agent and other components to the solution to prepare a coating solution, applying the coating solution to a support, and then drying the coated material. Examples of the organic solvent for dissolving the polyimide resin therein include n-hexane, cyclohexane, diglyme, xylene, toluene, ethyl acetate, tetrahydrofurane, methyl ethyl ketone, acetone, cyclohexanone, 1,4-dioxane, 1,3-dioxane, dimethyl acetate, N-methyl-2-pyrrolidone, dimethyl sulfoxide, dimethyl formamide, dimethyl acetamide, y-butyrolactone, ethanol, and methanol. Coating and drying can be carried out by ordinary methods. Drying is normally effected at a temperature of not higher than 300° C., preferably not higher than 200° C. In the case where as the support there is used a polyethylene terephthalate, drying is preferably effected at a temperature of from 80° C. to 150° C.

When the amount of the binder incorporated in the light-to-heat conversion layer is too small, the resulting light-to-heat conversion layer exhibits a deteriorated cohesive force and thus can be easily transferred with the formed image to the image-receiving sheet, causing the image to be stained. When the amount of the polyimide resin to be incorporated is too great, the thickness of the light-to-heat conversion layer must be raised to attain a desired absorbance, causing sensitivity drop. The ratio of solid content of photo-heat conversion material to binder in the light-to-heat conversion layer by weight is preferably from 1:20 to 2:1, particularly from 1:10 to 2:1.

The thickness of the light-to-heat conversion layer is preferably reduced to enhance the sensitivity of the heat transfer sheet as mentioned above. The thickness of the light-to-heat conversion layer is preferably from 0.03 μm to 1.0 μm, more preferably from 0.05 μm to 0.5 μm. The light-to-heat conversion layer preferably exhibits an optical density of from 0.80 to 1.26, more preferably from 0.92 to 1.15 with respect to light having a wavelength of 808 nm to enhance the transfer sensitivity of the image-forming layer. When the optical density of the light-to-heat conversion layer at a laser peak wavelength falls below 0.80, the light-to-heat conversion layer can insufficiently convert incident light to heat, causing drop of transfer sensitivity. On the contrary, when the optical density of the light-to-heat conversion layer at a laser peak wavelength exceeds 1.26, the function of the light-to-heat conversion layer can be affected during recording, causing fogging. The term “optical density of the light-to-heat conversion layer of the heat transfer sheet” as used herein is meant to indicate the absorbance of the light-to-heat conversion layer at a peak wavelength of laser light used. The absorbance of the light-to-heat conversion layer can be measured by means of any known spectrophotometer. In the present invention, a Type UV-240 ultraviolet spectrophotometer (produced by Shimadzu Corp.) was used. The optical density is obtained by subtracting the value of the support from the value of the light-to-heat conversion layer including the support.

(Image-Forming Layer)

The image-forming layer comprises at least a pigment incorporated therein for forming an image after being transferred to the image-receiving sheet, and further, the image-forming layer comprises a binder for forming a layer, and optionally other components incorporated therein.

Pigments are generally roughly divided into two groups, i.e., inorganic pigment and organic pigment. The former pigment is excellent in the transparency of coating layer. The latter pigment is generally excellent in the opacity. Thus, pigments may be selected depending on the purpose. In the case where the foregoing heat transfer sheet is used for color correction of print, organic pigments coincident with or close in color tone to yellow, magenta, cyan and black commonly used in printing ink may be used. Besides these pigments, metal powders, fluorescent pigments, etc. may be used. Examples of pigments which are preferably used herein include azo-based pigments, phthalocyanine-based pigments, anthraquinone-based pigments, dioxazine-based pigments, quinacridone-based pigments, isoindolinone-based pigments, and nitro-based pigments. Pigments which can be incorporated in the image-forming layer will be listed below by color hues, but the present invention should not be construed as being limited thereto.

1) Yellow Pigment

Pigment Yellow 12 (C. I. No. 21090) (e.g., Permanent Yellow DHG (produced by Clariant Japan Co., Ltd.), Lionol Yellow 1212B (produced by TOYO INK MFG. CO., LTD.), Irgalite Yellow LCT (produced by Ciba Specialty Chemicals Co., Ltd.), Symuler Fast Yellow GTF 219 (produced by DAINIPPON INK & CHEMICALS, INC.));
Pigment Yellow 13 (C. I. No. 21100) (e.g., PermanentYellow GR (produced by Clariant Japan Co., Ltd.), Lionol Yellow 1313 (produced by TOYO INK MFG. CO., LTD.));
Pigment Yellow 14 (C. I. No. 21095) (e.g., Permanent Yellow G (produced by Clariant Japan Co., Ltd.), Lionol Yellow 1401-G (produced by TOYO INK MFG. CO., LTD.), Seika Fast Yellow 2270 (produced by DAINICHISEIKA COLOUR & CHEMICALS MFG. CO., LTD.), Symuler Fast Yellow 4400 (produced by DAINIPPON INK & CHEMICALS, INC.));
Pigment Yellow 17 (C. I. No. 21105) (e.g., Permanent Yellow GG02 (produced by Clariant Japan Co., Ltd.), Symuler Fast Yellow 8GF (produced by DAINIPPON INK & CHEMICALS, INC.);
Pigment Yellow 155 (e.g., Graphtol Yellow 3GP (produced by Clariant Japan Co., Ltd.));
Pigment Yellow 180 (C. I. No. 21290) (e.g., Novoperm Yellow P-HG (produced by Clariant Japan Co., Ltd.), PV Fast Yellow HG (produced by Clariant Japan Co., Ltd.);
Pigment Yellow 139 (C. I. No. 56298) (e.g., Novoperm Yellow M2R 70 (produced by Clariant Japan Co., Ltd.))
   2) Magenta Pigment
Pigment Red 57:1 (C. I. No. 15850:1) (e.g., Graphtol Rubine L6B (produced by Clariant Japan Co., Ltd.), Lionol Red 6B-4290G (produced by TOYO INK MFG. CO., LTD.), Irgalite Rubine 4BL (produced by Ciba Specialty Chemicals Co., Ltd.), Symuler Brilliant Carmine 6B-229 (produced by DAINIPPON INK & CHEMICALS, INC.));
Pigment Red 122 (C. I. No. 73915) (e.g., Hosterperm Pink E (produced by Clariant Japan Co., Ltd.), Lionogen Magenta 5790 (produced by TOYO INK MFG. CO., LTD.), Fastogen Super Magenta RF (produced by DAINIPPON INK & CHEMICALS, INC.));
Pigment Red 53:1 (C. I. No. 15585:1) (e.g., Permanent Lake Red LCY (produced by Clariant Japan Co., Ltd.), Symuler Lake Red C conc (produced by DAINIPPON INK & CHEMICALS, INC.))
Pigment Red 48:1 (C. I. No. 15865:1) (e.g., Lionol Red 2B 3300 (produced by TOYO INK MFG. CO., LTD.), Symuler Red NRY (produced by DAINIPPON INK & CHEMICALS, INC.));
Pigment Red 48:2 (C. I. No. 15865:2) (e.g., Permanent Red W2T (produced by Clariant Japan Co., Ltd.), Lionol Red LX235 (produced by TOYO INK MFG. CO., LTD.), Symuler Red 3012 (produced by DAINIPPON INK & CHEMICALS, INC.));
Pigment Red 48:3 (C. I. No. 15865:3) (e.g., Permanent Red 3RL (produced by Clariant Japan Co., Ltd.), Symuler Red 2BS (produced by DAINIPPON INK & CHEMICALS, INC.));
Pigment Red 177 (C. I. No. 65300) (e.g., Cromophtal Red A2B (produced by Ciba Specialty Chemicals Co., Ltd.))
   3) Cyan Pigment
Pigment Blue 15 (C. I. No. 74160) (e.g., Lionol Blue 7027 (produced by TOYO INK MFG. CO., LTD.), Fastogen Blue BB (produced by DAINIPPON INK & CHEMICALS, INC.));
Pigment Blue 15:1 (C. I. No. 74160) (e.g., Hosterperm Blue A2R (produced by Clariant Japan Co., Ltd.), Fastogen Blue 5050 (produced by DAINIPPON INK & CHEMICALS, INC.));
Pigment Blue 15:2 (C. I. No. 74160) (e.g., Hosterperm Blue AFL (produced by Clariant Japan Co., Ltd.), Irgalite Blue BSP (produced by Ciba Specialty Chemicals Co., Ltd.), Fastogen Blue GP (produced by DAINIPPON INK & CHEMICALS, INC.));
Pigment Blue 15:3 (C. I. No. 74160) (e.g., Hosterperm Blue B2G (produced by Clariant Japan Co., Ltd.), Lionol Blue FG7330 (produced by TOYO INK MFG. CO., LTD.), Cromophtal Blue 4GNP (produced by Ciba Specialty Chemicals Co., Ltd.), Fastogen Blue FGF (produced by DAINIPPON INK & CHEMICALS, INC.));
Pigment Blue 15:4 (C. I. No. 74160) (e.g., Hosterperm Blue BFL (produced by Clariant Japan Co., Ltd.), Cyanine Blue 700-10FG (produced by TOYO INK MFG. CO., LTD.), Irgalite Blue GLNF (produced by Ciba Specialty Chemicals Co., Ltd.), Fastogen Blue FGS (produced by DAINIPPON INK & CHEMICALS, INC.));
Pigment Blue 15:6 (C. I. No. 74160) (e.g., Lionol Blue ES (produced by TOYO INK MFG. CO., LTD.));
Pigment Blue 60 (C. I. No. 69800) (e.g., Hosterperm Blue RL01 (produced by Clariant Japan Co., Ltd.), Lionogen Blue 6501 (produced by TOYO INK MFG. CO., LTD.))
   4) Black Pigment
Pigment Black 7 (Carbon Black C. I. No. 77266) (e.g., Mitsubishi Carbon Black MA100 (produced by Mitsubishi Chemical Corporation), Mitsubishi Carbon Black #5 (produced by Mitsubishi Chemical Corporation), Black Pearls 430 (produced by Cabot Co., Ltd.))

For pigments employable herein, reference can be made to “Ganryou Binran (Handbook of Pigments)”, Japan Association of Pigment Technology, Seibundo Shinkosha, 1989, “COLOUR INDEX”, THE SOCIETY OF DYES & COLOURIST, THIRD EDTION, 1987, etc., and proper pigments can be selected from these commercial products.

The average particle diameter of the pigment is preferably from 0.03 μm to 1 μm, more preferably from 0.05 μm to 0.5 μm.

When the particle diameter of the pigment is 0.03 μm or more, it doesn't add to the dispersion cost or prevents the dispersion from undergoing gelation, and on the contrary, when the particle diameter of the pigment is 1 μm or less, the resulting pigment is free of coarse particles, giving a good adhesion between the image-forming layer and the image-receiving layer or improving the transparency of the image-forming layer.

As the binder to be incorporated in the image-forming layer there is preferably used an amorphous organic high molecular polymer having a softening point of from 40° C. to 150° C. Examples of the amorphous organic high molecular polymer employable herein include butyral resin, polyamide resin, polyethyleneimine resin, sulfonamide resin, polyester polyol resin, petroleum resin, and homopolymer or copolymer of styrene such as styrene, vinyl toluene, α-methylstyrene, 2-methylstyrene, chlorostyrene, vinylbenzoic acid, sodium vinylbenzenesulfonate, and aminostyrene, derivative or substitution product thereof, and homopolymer or copolymer of vinyl monomers such as methacrylic acid ester (e.g., methyl methacrylate, ethyl methacrylate, butyl methacrylate, hydroxyethyl methacrylate), methacrylic acid, acrylic acid ester (e.g., methyl acrylate, ethyl acrylate, butyl acrylate, α-ethylhexyl acrylate), acrylic acid, diene (e.g., butadiene, isoprene), acrylonitrile, vinylether, maleic acid, maleic acid ester, maleic anhydride, cinnamic acid, vinyl chloride and vinyl acetate. Two or more of these resins may be used in admixture.

The image-forming layer preferably comprises a pigment incorporated therein in an amount of from 30% to 70% by weight, more preferably from 30% to 50% by weight. The image-forming layer also preferably comprises a resin incorporated therein in an amount of from 30% to 70% by weight, more preferably from 40% to 70% by weight.

The image-forming layer may comprise the following components \textcircled{1} to \textcircled{3} incorporated therein as the other components.

\textcircled{1} Wax

Examples of wax employable herein include mineral wax, natural wax, and synthetic wax. Examples of the mineral wax include petroleum wax such as paraffin wax, microcrystalline wax, ester wax and oxidized wax, montan wax, ozokerite, and ceresine wax. Particularly preferred among these waxes is paraffin wax. A paraffin wax is separated from petroleum, and various paraffin waxes having different melting points are commercially available.

Examples of the natural wax include vegetable waxes such as carnauba wax, Japan wax, Ouricury wax and esparto wax, and animal waxes such as beeswax, insect wax, Shellac wax and whale wax.

The aforesaid synthetic wax is generally used as a lubricant, and the synthetic wax is normally made of a higher aliphatic compound. Examples of such a synthetic wax will be given below.

1) Aliphatic Acid-Based Waxes

Straight-chain saturated aliphatic acid represented by the following general formula:
CH₃(CH₂)ₙCOOH
wherein n represents an integer of from 6 to 28. Specific examples of such a straight-chain saturated aliphatic acid include stearic acid, behenic acid, palmitic acid, 12-hydroxystearic acid, and azelaic acid.

Other examples of aliphatic acid-based waxes include salts of these aliphatic acids with metal (e.g., K, Ca, Zn, Mg).

2) Aliphatic Acid Ester-Based Waxes

Specific examples of the aliphatic acid ester employable herein include ethyl stearate, lauryl stearate, ethyl behenate, hexyl behenate, and behenyl myristate.

3) Aliphatic Acid Amide-Based Waxes

Specific examples of the aliphatic acid amide-basedwaxes employable herein include stearic acid amide, and lauric acid amide.

4) Aliphatic Alcohol-Based Waxes

Straight-chain saturated aliphatic alcohol represented by the following general formula:
CH₃(CH₂)ₙOH
wherein n represents an integer of from 6 to 28. Specific examples of the straight-chain saturated aliphatic alcohol employable herein include stearyl alcohol.

Particularly preferred among the synthetic waxes 1) to 4) are higher aliphatic acid amides such as stearic acid amide and lauric acid amide. These wax-based compounds may be used singly or in proper combination as necessary.

\textcircled{2} Plasticizer

As the plasticizer there is preferably used an ester compound. Examples of such an ester compound include known plasticizers such as phthalic acid ester (e.g., dibutyl phthalate, di-n-octyl phthalate, di(2-ethylhexyl) phthalate, dinonyl phthalate, dilauryl phthalate, butyllauryl phthalate and butylbenzyl phthalate, aliphatic dibasic acid ester (e.g., di(2-ethylhexyl) adipate and di(2-ethylhexyl) sebacate, phosphoric acid triester (e.g., tricresyl phosphate, tri(2-ethylhexyl) phosphate), polyolpolyester (e.g., polyethylene glycolester), and epoxy (e.g., epoxyaliphatic acid ester). Preferred among these plasticizers is ester of vinyl monomer. Particularly preferred among these plasticizers is ester of acrylic acid or methacrylic acid because it exerts a great effect of enhancing transfer sensitivity, eliminating uneven transfer and adjusting elongation at break.

Examples of the acrylic or methacrylic acid ester compound employable herein include polyethylene glycol dimethacrylate, 1,2,4-butanetriol trimethacrylate, trimethylolethane triacrylate, pentaerythritol acrylate, pentaerythritol tetraacrylate, and dipentaerythritol polyacrylate.

The plasticizer may be high molecular, and in particular, a polyester is preferred because it exerts a great plasticizing effect and can be difficultly dispersed during storage. Examples of the polyester include sebacic acid-based polyester, and adipic acid-based polyester.

The additives to be incorporated in the image-forming layer are not limited to the foregoing compounds. The foregoing plasticizers may be used singly or in combination of two or more thereof.

When the content of the additives in the image-forming layer is too great, the resolution of transfer image can be deteriorated. Further, the strength of the image-forming layer itself can be deteriorated. Moreover, the resulting deterioration of the adhesion between the light-to-heat conversion layer and the image-forming layer can cause the unexposed area to be transferred to the image-receiving sheet. From the foregoing standpoint of view, the content of the wax is preferably from 0.1% to 30% by weight, more preferably from 1 to 20% by weight based on the total solid content in the image-forming layer. The content of the plasticizer is preferably from 0.1% to 20% by weight, more preferably from 1 to 10% by weight based on the total solid content in the image-forming layer.

\textcircled{3} Others

The image-forming layer may further comprise a surface active agent, an inorganic or organic particulate material (e.g., metal powder, silica gel), an oil (e.g., linseed oil, mineral oil), a thickening agent, an antistat, etc. incorporated therein besides the foregoing components. The incorporation of a material capable of absorbing light having the wavelength of light source for use in image recording in the image-forming layer makes it possible to minimize the energy required for transfer except in the case where a black image is obtained. As the material capable of absorbing light having the wavelength of light source there may be used either a pigment or a dye. In the case where a color image is obtained, it is preferred from the standpoint of color reproducibility that an infrared light source such as semiconductor laser is used for image recording and a dye having little absorption in the visible light range and a great absorption in the range of wavelength of light source is used. Examples of the near infrared dyes include compounds disclosed in JP-A-3-103476.

The image-forming layer can be provided by a process which comprises preparing a coating solution having a pigment and the foregoing binder dissolved or dispersed therein, applying the coating solution to the light-to-heat conversion layer (or to the heat-sensitive peel layer, if any provided on the light-to-heat conversion layer), and then drying the coated material. Examples of the solvent to be used in the preparation of the coating solution include n-propyl alcohol, methyl ethyl ketone, propylene glycol monomethyl ether (MFG), methanol, and water. Coating and drying can be carried out by ordinary methods.

On the light-to-heat conversion layer in the heat transfer sheet may be provided a heat-sensitive peel layer comprising a heat-sensitive material which produces a gas or releases water of adhesion or the like when acted upon by heat generated in the light-to-heat conversion layer to lower the adhesion between the light-to-heat conversion layer and the image-forming layer. Examples of such a heat-sensitive material employable herein include compound (polymer or low molecular compound) which itself undergoes decomposition or modification to produce a gas when acted upon by heat, and compound (polymer or low molecular compound) which absorbs or adsorbs a volatile gas such as water in a considerable amount. These compounds may be used in combination.

Examples of the polymer which undergoes decomposition or modification to produce a gas when acted upon heat include self-oxidative polymer such as nitrocellulose, halogen-containing polymer such as chlorinated polyolefin, chlorinated rubber, polyrubber chloride, polyvinyl chloride and polyvinylidene chloride, acrylic polymer such as polyisobutyl methacrylate having a volatile compound such as water adsorbed thereto, cellulose ester such as ethyl cellulose having a volatile compound such as water adsorbed thereto, and natural polymer compound such as gelatin having a volatile compound such as water adsorbed thereto. Examples of the low molecular compound which undergoes decomposition or modification to produce a gas when acted upon by heat include a compound which undergoes thermal decomposition to produce a gas such as diazo compound and azide compound.

The thermal decomposition or modification of the heat-sensitive material preferably occurs at a temperature of not higher than 280° C., more preferably not higher than 230° C.

In the case where as the heat-sensitive material of the light-to-heat conversion layer there is used a low molecular compound, the low molecular compound is preferably used in combination with a binder. As the binder there may be used the foregoing polymer which itself undergoes decomposition or modification to produce a gas when acted upon by heat. However, an ordinary binder having no such properties may be used. In the case where a heat-sensitive low molecular compound and a binder are used in combination, the ratio of former to latter by weight is preferably from 0.02:1 to 3:1, more preferably from 0.05:1 to 2:1. The heat-sensitive peel layer is preferably covered by the light-to-heat conversion layer almost on the entire surface thereof. The thickness of the heat-sensitive peel layer is normally from 0.03 μm to 1 μm, preferably from 0.05 μm to 0.5 μm.

In the case of heat transfer sheet comprising a light-to-heat conversion layer, a heat-sensitive peel layer and an image-forming layer laminated in this order on a support, the heat-sensitive peel layer undergoes decomposition or modification to produce a gas when acted upon by a heat transferred from the light-to-heat conversion layer. The decomposition or gas production causes the heat-sensitive peel layer to partly disappear or the occurrence of cohesive failure in the heat-sensitive peel layer, deteriorating the adhesion between the light-to-heat conversion layer and the image-forming layer. Therefore, when the heat-sensitive peel layer shows some behavior, a part of the heat-sensitive peel layer adheres to the image-forming layer and appears on the surface of the finally formed image, occasionally causing stain on the image. Accordingly, it is preferred that the heat-sensitive peel layer be little colored, that is, a high transparency is shown with respect to visible light to prevent visual stain from appearing on the image formed even if the transfer of heat-sensitive peel layer occurs. In some detail, the absorbance of the heat-sensitive peel layer is not greater than 50%, preferably not greater than 10% with respect to visible light.

The heat transfer sheet may have a light-to-heat conversion layer made of a light-to-heat conversion layer coating solution having the foregoing heat-sensitive material added thereto to provide a layer which acts as both a light-to-heat conversion layer and a heat-sensitive layer instead of having an independent heat-sensitive peel layer.

It is preferred that the heat transfer sheet exhibits a static friction coefficient of not greater than 0.35, preferably not greater than 0.20 on the uppermost layer on the image-forming layer side thereof. When the static friction coefficient of the outermost layer is not greater than 0.35, the roll can be prevented from being stained during the conveyance of the heat transfer sheet, making it possible to enhance the quality of the image thus formed. The measurement of static friction coefficient can be carried out by the method disclosed in Japanese Patent Application No. 2000-85759 (paragraph (0011)).

The surface of the image-forming layer preferably has a Smoothster value of from 0.5 to 50 mmHg (approximately equal to 0.0665 to 6.65 KPa), preferably from 1.0 to 20 mmHg (approximately equal to 0.13 to 2.7 KPa) and Ra of from 0.05 to 0.4 μm at 23° C. and 55% RH. In this arrangement, the number of microvoids at which the image-receiving layer and the image-forming layer don't come in contact with each other can be reduced to facilitate transfer and improve image quality. The value of Ra can be measured using a surface roughness meter (Surfcom, produced by TOKYO SEIKI CO., LTD.) according to JIS B0601. The surface hardness of the image-forming layer is not smaller than 10 g with a sapphire needle. The charged potential of the image-forming layer is preferably from −100 V to 100 V after 1 second of grounding following electrification according to Test Standard 4046 of Federal Government of U.S.A. The surface resistivity of the image-forming layer is preferably not greater than 10⁹ Ω at 23° C. and 55% RH.

The image-receiving sheet to be used in combination with the heat transfer sheet will be further described hereinafter.

[Image-Receiving Sheet]

(Layer Configuration)

The image-receiving sheet normally comprises one or more image-receiving layers provided on a support, and if necessary, one or more of any of cushioning layer, peel layer and interlayer are provided interposed between the support and the image-receiving layer. The image-receiving sheet preferably comprises a back layer provided on the support on the side thereof opposite the image-receiving layer from the standpoint of conveyability.

(Support)

As the support there may be used an ordinary sheet-shaped substrate such as plastic sheet, metal sheet, glass sheet, resin-coated paper, paper and composite thereof. Examples of the plastic sheet employable herein include polyethylene terephthalate sheet, polycarbonate sheet, polyethylene sheet, polyvinyl chloride sheet, polyvinylidene chloride sheet, polystyrene sheet, styrene-acrylonitrile sheet, and polyester sheet. Examples of paper employable herein include final printing paper, and coated paper.

The support preferably has microvoids to improve image quality. The support can be prepared by a process which comprises melt-extruding a molten mixture of a thermoplastic resin, an inorganic pigment and a filler made of a polymer incompatible with the thermoplastic resin into a single-layer or multi-layer film, and then uniaxially or biaxially orienting the film. In this case, the voids can be determined by properly selecting the resin or filler and predetermining the mixing proportion, orienting conditions, etc.

As the thermoplastic resin there is preferably used a polyolefin resin such as polypropylene or polyethylene terephthalate resin because it has a good crystallinity and orientability and can easily form voids therein. The polyolefin resin or polyethylene terephthalate resin is preferably used as a main component properly in combination with a small amount of other thermoplastic resins. The inorganic pigment to be used as filler preferably has an average particle diameter of from 1 μm to 20 μm. Examples of the inorganic pigment employable herein include calcium carbonate, clay, diatomaceous earth, titanium oxide, aluminum hydroxide, and silica. As the incompatible resin to be used as filler there is preferably used a polyethylene terephthalate if a polypropylene is used as thermoplastic resin. For the details of the support having microvoids, reference can be made to JP-A-2001-105752.

The content of the filler such as inorganic pigment in the support is normally from about 2% to 30% by volume.

The thickness of the image-receiving sheet is normally from 10 μm to 400 μm, preferably from 25 μm to 200 μm. The support may be subjected to surface treatment such as corona discharge treatment and glow discharge treatment to enhance its adhesion to the image-receiving layer (or cushioning layer) or the adhesion of the heat transfer sheet to the image-forming layer.

(Image-Receiving Layer)

The image-receiving sheet may comprise one or more image-receiving layers provided on the support so that the image-forming layer is transferred to and fixed on the surface thereof. The image-receiving layer is preferably a layer mainly composed of an organic polymer binder. The binder is preferably a thermoplastic resin. Examples of the thermoplastic resin employable herein include homopolymer and copolymer of acrylic monomers such as acrylic acid, methacrylic acid, acrylic acid ester and methacrylic acid ester, cellulose polymer such as methyl cellulose, ethyl cellulose and cellulose acetate, homopolymer and copolymer of vinyl monomers such as polystyrene, polyvinyl pyrrolidone, polyvinyl butyral, polyvinyl alcohol and polyvinyl chloride, condensed polymer such as polyester and polyamide, and rubber polymer such as butadiene-styrene copolymer. The binder to be incorporated in the image-receiving layer is preferably a polymer having a glass transition temperature (Tg) of 90° C. or less to provide a proper adhesion to the image-forming layer. To this end, the image-receiving layer can comprise a plasticizer incorporated therein. The binder polymer preferably has Tg of 30° C. or more to prevent blocking between sheets. It is particularly preferred that the binder polymer to be incorporated in the image-receiving layer be the same as or analogous to that of the image-forming layer to enhance the adhesion to the image-forming layer during laser recording and hence the sensitivity or image strength.

The surface of the image-receiving layer preferably has a Smoothster value of from 0.5 to 50 mmHg (approximately equal to 0.0665 to 6.65 kPa), preferably from 1.0 to 20 mmHg (approximately equal to 0.13 to 2.7 kPa) and Ra of from 0.05 to 0.4 μm at 23° C. and 55% RH. In this arrangement, the number of microvoids at which the image-receiving layer and the image-forming layer don't come in contact with each other can be reduced to facilitate transfer and improve image quality. The value of Ra can be measured using a surface roughness meter (Surfcom, produced by TOKYO SEIKI CO., LTD.) according to JIS B0601. The charged potential of the image-receiving layer is preferably from −100 V to 100 V after 1 second of grounding following electrification according to Test Standard 4046 of Federal Government of U.S.A. The surface resistivity of the image-receiving layer is not greater than 10⁹ Ω at 23° C. and 55% RH. The image-receiving layer has a surface static friction coefficient of preferably not greater than 0.8. The image-receiving layer preferably has a surface energy of from 23 to 35 mJ/m².

In the case where an image which has been transferred to the image-receiving layer is transferred to final printing paper or the like, at least one of the image-receiving layers is preferably formed by a photo-setting material. As the composition of the photo-setting material there may be used a combination of (a) a photopolymerizable monomer made of at least one polyfunctional vinyl or vinylidene compound capable of producing a photopolymerization product upon addition polymerization, (b) an organic polymer, (c) a photopolymerization initiator and optionally a heat polymerization inhibitor. As the polyfunctional vinyl monomer there may be used an unsaturated ester of polyol, particularly acrylic or methacrylic acid ester (e.g., ethylene glycol diacrylate, pentaerythritol tetraacrylate).

As the organic polymer there may be used the polymer for the image-receiving layer. As the photopolymerization initiator there may be used an ordinary photoradical polymerization initiator such as benzophenone and Michler's ketone in an amount of from 0.1% to 20% by weight based on the mass of the image-receiving layer.

The thickness of the image-receiving layer is from 0.3 μm to 7 μm, preferably from 0.7 μm to 4 μm. When the thickness of the image-receiving layer is 0.3 μm or more, desired film strength can be secured during the retransfer to final printing paper. By predetermining the thickness of the image-receiving layer to 4 μm or less, the gloss of the image which has been retransferred to final paper can be suppressed to improve the approximation to desired printed matter.

(Other Layers)

A cushioning layer may be provided interposed between the support and the image-receiving layer. The provision of such a cushioning layer makes it possible to enhance the adhesion between the image-forming layer and the image-receiving layer during transfer by laser heat and hence improve image quality. Further, even when foreign matters enter into the gap between the heat transfer sheet and the image-receiving layer during recording, the deformation of the cushioning layer causes the reduction of the gap between the image-receiving layer and the image-forming layer, making it possible to reduce the size of image defects such as white mark. Moreover, in the case where an image which has been transferred and formed is transferred to final printing paper separately prepared, the surface of the image-receiving layer deforms according to the surface roughness of paper, making it possible to improve the transferability of the image-receiving layer. Further, the cushioning layer can lower the gloss of the transferred material, making it possible to enhance the approximation to desired printed matter.

The cushioning layer is preferably formed by a material having a low elastic modulus, a material having rubber elasticity or a thermoplastic resin which easily softens when heated so as to easily undergo deformation when the image-receiving layer is stressed and attain the foregoing effect.

In order to allow foreign matters such as dust to sink thereinto, the cushioning layer preferably exhibits a penetration (25° C., 100 g, 5 seconds) of not smaller than 10 according to JIS K2530. The glass transition temperature of the cushioning layer is not higher than 80° C., preferably not higher than 25° C. The softening point of the cushioning layer is preferably from 50° C. to 200° C. It is preferably practiced to incorporate a plasticizer in the binder to adjust the physical properties, e.g., Tg of the cushioning layer.

Specific examples of the material to be used as the binder for the cushioning layer include rubbers such as urethane rubber, butadiene rubber, nitrile rubber, acryl rubber and natural rubber, polyethylene, polypropylene, polyester, styrene-butadiene copolymer, ethylene-vinyl acetate copolymer, ethylene-acryl copolymer, vinyl chloride-vinyl acetate copolymer, vinylidene chloride resin, plasticizer-containing vinyl chloride resin, polyamide resin, and phenolic resin.

The thickness of the cushioning layer depends on the resin used and other conditions but is normally from 3 μm to 100 μm, preferably from 10 μm to 52 μm.

The image-receiving layer and the cushioning layer need to be bonded to each other until the step of laser recording. In order to transfer an image to final printing paper, the two layers are preferably provided such that they can be peeled off each other. In order to facilitate peeling, a peel layer is preferably provided interposed between the cushioning layer and the image-receiving layer to a thickness of from 0.1 μm to 2 μm. When the thickness of the peel layer is too great, the desired properties of the cushioning layer can difficultly appear. Thus, the thickness of the peel layer need to be adjusted by the kind of the peel layer.

In the case where the peel layer is provided, specific examples of the binder for the peel layer include polyolefin, polyester, polyvinyl acetal, polyvinyl formal, polyparabanic acid, methyl polymethacrylate, polycarbonate, ethyl cellulose, nitrocellulose, methyl cellulose, carboxymethyl cellulose, hydroxypropyl cellulose, polyvinyl alcohol, polyvinyl chloride, urethane resin, fluororesin, styrene such as polystyrene and acrylonitrile styrene, crosslinking product thereof, thermosetting resin having Tg of not lower than 65° C. such as polyamide, polyimide, polyetherimide, polysulfone, polyethersulfone and aramide, and hardening product thereof. As the hardening agent there may be used an ordinary hardening agent such as isocyanate and melamine.

Taking into account the foregoing physical properties, a polycarbonate, acetal or ethyl cellulose can be preferably used as a binder for the peel layer from the standpoint of storage properties, and further, it is particularly preferred that the image-receiving layer be formed by an acrylic resin to provide a good peelability during the retransfter of the image formed by laser heat transfer.

Alternatively, a layer which exhibits an extremely lowered adhesion to the image-receiving layer during cooling can be used as a peel layer. In some detail, such a layer may be mainly composed of a hot-melt compound such as wax and binder or a thermoplastic resin.

As the hot-melt compound there may be used a material as described in JP-A-63-193886. Particularly preferred examples of such a material include microcrystalline wax, paraffin wax, and carnauba wax. As the thermoplastic resin there is preferably used an ethylene copolymer such as ethylene-vinyl acetate resin or cellulose resin.

The peel layer may comprise a higher aliphatic acid, higher alcohol, higher aliphatic acid ester, amide, higher amine, etc. incorporated therein as additives as necessary.

Another structure of the peel layer is a layer which melts or softens upon heating to undergo cohesive failure itself to provide peelability. Such a peel layer preferably comprises a supercooling material incorporated therein.

Examples of such a supercooling material include poly-ε-caprolactone, polyoxyethylene, benzotriazole, tribenzylamine, and vanilin.

The other structure of peel layer further comprises a compound for lowering the adhesion to the image-receiving layer incorporated therein. Examples of such a compound include silicone resin such as silicone oil, fluororesin such as teflon and fluorine-containing acrylic resin, polysiloxane resin, acetal resin such as polyvinyl butyral, polyvinyl acetal and polyvinyl formal, solid wax such as polyethylene wax and amide wax, and fluorine-based and phosphoric acid ester-based surface active agents.

As the method for forming a peel layer there may be used a method which comprises applying a solution or latex dispersion of the foregoing material in a solvent to the cushioning layer by a coating method such as blade coating, roll coating, bar coating, curtain coating and gravure coating or extrusion lamination method such as hot melt method. Alternatively, a method may be used which comprises applying a solution or latex dispersion of the foregoing material in a solvent to a tentative base by the foregoing method, laminating the laminate with the cushioning layer, and then peeling the tentative base off the laminate.

The image-receiving layer to be combined with the heat transfer sheet may have an image-receiving layer which also acts as a cushioning layer, and in this structure, the image-receiving sheet may consist of a support and a cushioning image-receiving layer or a support, an undercoating layer and a cushioning image-receiving layer. In this case, too, the cushioning image-receiving layer is preferably provided peelably such that the image can be retransferred to final printing paper. In this arrangement, the image which has been retransferred to final printing paper has an excellent gloss.

The thickness of the cushioning image-receiving layer is from 5 μm to 100 μm, preferably from 10 μm to 40 μm.

The image-receiving sheet preferably comprises a back layer provided on the side of the support opposite the image-receiving layer to have an improved conveyability. The back layer preferably comprises an antistat such as surface active agent and particulate tin oxide and a matting agent such as silicon oxide and particulate PMMA incorporated therein to improve the conveyability of the image-receiving sheet in the recording device.

The foregoing additives may be incorporated not only in the back layer but also in the image-receiving layer and other layers as necessary. The kind of these additives cannot be unequivocally defined depending on the purpose. For example, a matting agent having an average particle diameter of from 0.5 μm to 10 μm may be incorporated in the layer in an amount of from about 0.5% to 80%. As an antistat there may be used one properly selected from the group consisting of various surface active agents and electrically-conducting agents such that the surface resistivity of the layer is not higher than 10¹² Ω, preferably not higher than 10⁹ Ω at 23° C. and 50% RH.

Examples of the binder to be incorporated in the back layer include various general-purpose polymers such as gelatin, polyvinyl alcohol, methyl cellulose, nitrocellulose, acetyl cellulose, aromatic polyamide resin, silicone resin, epoxy resin, alkyd resin, phenolic resin, melamine resin, fluororesin, polyimide resin, urethane resin, acrylic resin, urethane-modified silicone resin, polyethylene resin, polypropylene resin, polyester resin, teflon resin, polyvinyl butyral resin, vinyl chloride-based resin, polyvinyl acetate, polycarbonate, organic borone compound, aromatic ester, fluorinated polyurethane and polyethersulfone.

The arrangement such that the back layer is formed by crosslinking a crosslinkable water-soluble binder makes it possible to exert an effect on the prevention of the falling of powder of matting agent or improvement of the damage resistance of the back layer. This arrangement also has a great effect and blocking during storage.

This crosslinking process may be carried out by the action of heat, active rays and pressure, singly or in combination, depending on the properties of the crosslinking agent used. In some cases, the support may comprise an arbitrary adhesive layer provided on the back layer side thereof to render itself adhesive.

As the matting agent which is preferably incorporated in the back layer there may be used an organic or inorganic particulate material. Examples of the organic matting agent employable herein include particulate polymethyl methacrylate (PMMA), polystyrene, polyethylene, polypropylene and other radically polymerized polymer, and particulate condensed polymers such as particulate polyester and polycarbonate.

The back layer is preferably provided in an amount of from about 0.5 to 5 g/m². When the amount of the back layer falls below 0.5 g/m², the resulting coatability is unstable, causing troubles such as falling of powder of matting agent. On the contrary, when the amount of the back layer greatly exceeds 5 g/m², the preferred particle diameter of the matting agent greatly increases, causing the back layer to emboss the image-receiving layer during storage and hence causing lack or unevenness in the recorded image particularly in the heat transfer process involving the transfer of a thin image-forming layer.

The matting agent preferably has a number-average particle diameter of from 2.5 μm to 20 μm greater than the thickness of the binder layer in the back layer. The matting agent needs to comprise particles having a particle diameter of not smaller than 8 μm in an amount of not smaller than 5 mg/m², preferably from 6 to 600 mg/m². In this arrangement, defectives due to foreign matter can be eliminated. By using a matting agent having a particle diameter distribution such that the value σ/rn (coefficient of variation of particle diameter) obtained by dividing the standard deviation of particle diameter by the number-average particle diameter is not greater than 0.3, defectives caused by particles having an abnormally great particle diameter can be eliminated. Further, desired properties can be obtained even when the matting agent is used in a smaller amount. The variation coefficient is more preferably not greater than 0.15.

The back layer preferably comprises an antistat incorporated therein to prevent the triboelectric charge with the conveyor roll that causes the attraction of foreign matter. Examples of the antistat employable herein include cationic surface active agents, anionic surface active agents, nonionic surface active agents, polymer antistats, electrically-conductive particulate materials, and compounds as described in “11290 no Kagaku Shohin “11290 Chemical Products)”, Kagaku Kogyo Nipposha, pp. 875-876.

As the antistat to be incorporated in the back layer there may be used carbon black, a metal oxide such as zinc oxide, titanium oxide and tin oxide or an electrically-conductive particulate material such as organic semiconductor among the foregoing materials. In particular, the electrically-conductive particulate material cannot undergo dissociation from the back layer, making it possible to exert a stable antistatic effect regardless of atmosphere.

The back layer may further comprise a release agent such as active agent, silicone oil and fluororesin incorporated therein to render itself coatable or releasable.

It is particularly preferred that the back layer is provided when softening points measured by TMA (Thermomechanical Analysis) of the cushioning layer and the image-receiving layer are 70° C. or less.

TMA softening point is determined by observing the phase of the object to be measured while being heated at a constant rate under a constant load. In the present invention, TMA softening point is defined by the temperature at which the object to be measured begins to show a phase change. For the measurement of TMA softening point, a measuring instrument such as Thermoflex (produced by Rigaku Corp.) may be used.

The heat transfer sheet and the image-receiving sheet can be then processed such that the image-forming layer of the heat transfer sheet and the image-receiving layer of the image-receiving sheet are combined to form a laminate which can be used to form an image.

The laminate of heat transfer sheet and image-receiving sheet can be formed by any method. For example, the laminate can be easily obtained by laminating the image-forming layer of the heat transfer sheet and the image-receiving layer of the image-receiving sheet, and then passing the laminate over a pressure heat roller. In this process, the heating temperature is preferably not higher than 160° C. or not higher than 130° C.

Alternatively, the laminate can be obtained by the foregoing vacuum contact method. The vacuum contact method comprises winding the image-receiving sheet on a drum having suction holes for vacuum suction provided therein, and then allowing a heat transfer sheet having a size of slightly greater than that of the image-receiving sheet to come in vacuum-contact with the image-receiving sheet while air is being uniformly pushed out by a squeeze roller. A further method comprises mechanically sticking the image-receiving sheet to a metal drum under tension, and then similarly sticking the heat transfer sheet to the image-receiving sheet under tension so that they come in close contact with each other. Particularly preferred among these methods is vacuum contact method because any temperature controlling means such as heat roller is not required, facilitating rapid and uniform lamination.

The present invention will be further described in the following examples, but the present invention should not be construed as being limited thereto. The term “parts” as used hereinafter is meant to indicate “parts by weight” unless otherwise specified.

### EXAMPLE 1-1

Preparation of Heat Transfer Sheet K (Black)

[Preparation of Back Layer]

[Preparation of 1st Back Layer Coating Solution]

| | | |
|---|---|---|
| Aqueous dispersion of acrylic resin | 2 | parts |
| (Jurimer ET410; solid content: 20% | | |
| by weight; produced by Nihon Junyaku Co., Ltd.) | | |
| Antistat (aqueous dispersion of tin | 7.0 | parts |
| oxide-antimony oxide) (average particle | | |
| diameter: 0.1 μm; 17% by weight) | | |
| Polyoxyethylene phenyl ether | 0.1 | parts |
| Melamine compound | 0.3 | parts |
| (Sumitix Resin M-3, produced by SUMITOMO | | |
| CHEMICAL CO., LTD.) | | |
| Distilled water to make 100 parts in total | | |

[Formation of 1st Back Layer]

A biaxially oriented polyethylene terephthalate support (Ra on both sides: 0.01 μm) having a thickness of 75 μm was subjected to corona discharge treatment on one side (back surface) thereof. The 1st back layer coating solution was applied to the corona discharge-treated side of the polyethylene terephthalate support to a dry thickness of 0.03 μm, and then dried at a temperature of 180° C. for 30 seconds to form a 1st back layer thereon. The support had a Young's modulus of 450 Kg/mm² (approximately equal to 4.4 GPa) in the longitudinal direction and 500 Kg/mm² (approximately equal to 4.9 GPa) in the crosswise direction. The support had an F-5 value of 10 Kg/mm² (approximately equal to 98 MPa) in the longitudinal direction and 13 Kg/mm² (approximately equal to 127.4 MPa) in the crosswise direction. The support had a thermal shrinkage of 0.3% and 0.1% in the longitudinal direction and crosswise direction, respectively, at 100° C. for 30 minutes. The support had a breaking strength of 29 Kg/mm² (approximately equal to 196 MPa) in the longitudinal direction and 25 Kg/mm² (approximately equal to 245 MPa) in the crosswise direction and an elastic modulus of 400 Kg/mm² (approximately equal to 3.9 GPa).

[Preparation of 2nd Back Layer]

| | | |
|---|---|---|
| Polyolefin | 3.0 | parts |
| (Chemipearl S-120; 27% by weight, produced | | |
| by Mitsui Petrochemical Industries, Ltd.) | | |
| Antistat (aqueous dispersion of tin | 2.0 | parts |
| oxide-antimony oxide) (average particle | | |
| diameter: 0.1 μm; 17% by weight) | | |
| Colloidal silica (Snowtex C; 20% by | 2.0 | parts |
| mass; produced by Nissan Chemical | | |
| Industries, Ltd.) | | |
| Epoxy compound (Dinacoal EX-614B, | 0.3 | parts |
| produced by Nagase Kasei Co., Ltd.) | | |
| Distilled water to make 100 parts in total | | |

[Formation of 2nd Back Layer]

The 2nd back layer coating solution was applied to the 1st back layer to a dry thickness of 0.03 μm, and then dried at a temperature of 170° C. for 30 seconds to form a 2nd back layer thereon.

[Formation of Light-To-Heat Conversion Layer]

[Preparation of Light-To-Heat Conversion Layer Coating Solution]

The following components were mixed with stirring by a stirrer to prepare a light-to-heat conversion layer coating solution.

[Formulation of Light-To-Heat Conversion Layer Coating Solution]

| | |
|---|---|
| Infrared-absorbing dye | 7.6 parts |
| (“NK-2014”, cyanine dye having the | |
| following structure produced by | |
| Nihon Kanko Shikiso Co., Ltd.) | |
| 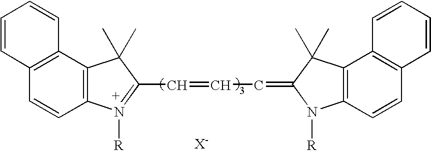 | |
| wherein R represents CH₃; and X⁻ represents ClO₄⁻. | |
| Polyimide resin having the following | 29.3 parts |
| structure | |
| (“Rikacoat SN-20F”; thermal decomposition | |
| temperature: 510° C.; produced by New Japan | |
| Chemical Co., Ltd.) | |
| 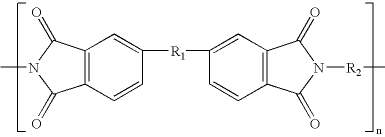 | |
| wherein R₁ represents SO₂; and R₂ represents | |
| 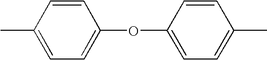 | |
| or | |
| 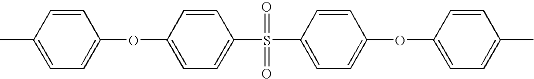 | |
| Exon naphtha | 5.8 parts |
| N-methylpyrrolidone (MAP) | 1,500 parts |
| Methyl ethyl keton | 360 parts |
| Surface active agent | 0.5 parts |
| (“Megafac F-176PF”; F-based surface | |
| active agent produced by DAINIPPON INK | |
| & CHEMICALS, INC.) | |
| Matting agent having the following | 14.1 parts |
| formulation | |

(Preparation of Matting Agent Dispersion)

10 parts of a spherically particulate silica having an average particle diameter of 1.5 μm (Seahostar KE-P150, produced by NIPPON SHOKUBAI CO., LTD.), 2 parts of a dispersant polymer (acrylic acid ester-styrene copolymer; Johncryl 611, produced by Johnson Polymer Co., Ltd.), 16 parts of methyl ethyl ketone and 64 parts of N-methylpyrrolidone were mixed. The mixture and 30 parts of glass beads having a diameter of 2 mm were then put into a 200 ml polyethylene vessel. The mixture was then subjected to dispersion by means of a pain shaker (produced by Toyo Seiki Seisakusho, Ltd.) for 2 hours to obtain a dispersion of a particulate silica.

[Formation of Light-To-Heat Conversion Layer on the Surface of Support]

The foregoing light-to-heat conversion layer coating solution was applied to one surface of a polyethylene terephthalate film having a thickness of 75 μm (support) by means of a wire bar. The coated material was then dried in a 120° C. oven for 2 minutes to form a light-to-heat conversion layer on the support. The light-to-heat conversion layer thus obtained was then measured for optical density at a wavelength of 808 nm by means of a Type UV-240 ultraviolet spectrophotometer (produced by Shimadzu Corp.) As a result, the light-to-heat conversion layer exhibited OD of 1.03. For the measurement of the thickness of the light-to-heat conversion layer, a cross-section of the light-to-heat conversion layer was observed under a scanning electron microscope. As a result, the light-to-heat conversion layer was confirmed to have a thickness of 0.3 μm on the average.

[Formation of Image-Forming Layer]

[Preparation of Black Image-Forming Layer Coating Solution]

The following components were put in the mill of a kneader where they were then subjected to pretreatment for dispersion while being given a shearing force with a small amount of a solvent being added thereto. To the dispersion thus obtained was then added the solvent until the following formulation was finally obtained. The dispersion was then subjected to dispersion in a sand mill for 2 hours to obtain a mother liquor of pigment dispersion.

[Formulation of Mother Liquor of Black Pigment Dispersion]

Formulation 1

| | | |
|---|---|---|
| Polyvinyl butyral | 12.6 | parts |
| (“Eslec B BL-SH”, produced by SEKISUI | | |
| CHEMICAL CO., LTD.) | | |
| Pigment Black 7 (Carbon Black C.I. No. | 4.5 | parts |
| 77266) (“Mitsubishi Carbon Black #5”, PVC | | |
| blackness: 1, produced by Mitsubishi | | |
| Chemical Corporation) | | |
| Dispersing aid (high molecular pigment | 0.8 | parts |
| dispersant) (“Solsperse S-20000”, produced | | |
| by ICI Co., Ltd.) | | |
| n-Propyl alcohol | 79.4 | parts |

Formulation 2

| | | |
|---|---|---|
| Polyvinyl butyral | 12.6 | parts |
| (“Eslec B BL-SH”, produced by SEKISUI | | |
| CHEMICAL CO., LTD.) | | |
| Pigment Black 7 (Carbon Black C.I. No. | 10.5 | parts |
| 77266) (“Mitsubishi Carbon Black MA100”, PVC | | |
| blackness: 10, produced by Mitsubishi | | |
| Chemical Corporation) | | |
| Dispersing aid (high molecular pigment | 0.8 | parts |
| dispersant) (“Solsperse S-20000”, produced | | |
| by ICI Co., Ltd.) | | |
| n-Propyl alcohol | 79.4 | parts |

Subsequently, the following components were mixed with stirring by a stirrer to prepare a black image-forming layer coating solution.

[Formulation of Black Image-Forming Layer Coating Solution]

| | |
|---|---|
| Mother liquor of black pigment | 185.7 parts |
| dispersion mentioned above | |

Formulation 1: Formulation 2=70:30

| | |
|---|---|
| Polyvinyl butyral | 11.9 parts |
| (“Eslec B BL-SH”, produced by SEKISUI | |
| CHEMICAL CO., LTD.) | |

Wax-Based Compound

| | | |
|---|---|---|
| Neutron 2 (amide stearate, produced by | 1.7 | parts |
| Nippon Fine chemical Co., Ltd.) | | |
| Diamide BM (amide behenate, produced by | 1.7 | parts |
| Nippon Chemical Co., Ltd.) | | |
| Diamide Y (amide laurate, produced by | 1.7 | parts |
| Nippon Chemical Co., Ltd.) | | |
| Diamide KP (amide palmitate, produced by | 1.7 | parts |
| Nippon Chemical Co., Ltd.) | | |
| Diamide L-200 (amide erucate, produced by | 1.7 | parts |
| Nippon Chemical Co., Ltd.) | | |
| Diamide O-200 (amide oleate, produced by | 1.7 | parts |
| Nippon Chemical Co., Ltd.) | | |
| Rosin | 11.4 | parts |
| (“KE-311”, produced by Arakawa Chemical | | |
| Industries, Ltd.) (formulation: resin acid: | | |
| 80 to 97%; resin acid components: abietic | | |
| acid: 30 to 40%; neoabietic acid: 10 to 20%; | | |
| dihydroabietic acid: 14%; tetrahydroabietic | | |
| acid: 14%) | | |
| Surface active agent | 2.1 | parts |
| (“Megafac F-176PF”; produced by DAINIPPON | | |
| INK & CHEMICALS, INC.; solid content: 20%) | | |
| Inorganic pigment | 7.1 | parts |
| (“MEK-ST”, 30% methyl ethyl ketone solution, | | |
| produced by Nissan Chemical Industries, Ltd.) | | |
| n-Propyl alcohol | 1,050 | parts |
| Methyl ethyl ketone | 295 | parts |

The black image-forming layer coating solution thus obtained was then measured for average particle diameter and proportion of particles having a diameter of not greater than 1 μm using a laser scattering process particle size distribution meter. As a result, the average particle diameter was 0.25 μm and the proportion of particles having a diameter of not greater than 1 μm was 0.5%.

[Formation of Black Image-Forming Layer on the Surface of Light-To-Heat Conversion Layer]

The foregoing black image-forming layer coating solution was applied to the surface of the light-to-heat conversion layer by means of a wire bar for 1 minute, and the coated material was then dried in a 100° C. oven for 2 minutes to form a black image-forming layer on the light-to-heat conversion layer. In this manner, a heat transfer sheet having a light-to-heat conversion layer and a black image-forming layer provided in this order on a support (hereinafter referred to as “heat transfer sheet K”; one having a yellow image-forming layer also provided on the support will be hereinafter referred to as “heat transfer sheet Y”, one having a magenta image-forming layer also provided on the support will be hereinafter referred to as “heat transfer sheet M”, one having a cyan image-forming layer also provided on the support will be hereinafter referred to as “heat transfer sheet C”) was prepared.

The heat transfer sheet K was then measured for the optical density (optical density: OD) of black image-forming layer using a Type TD-904 Macbeth densitometer (with a W filter). As a result, the heat transfer sheet K was confirmed to have OD of 0.91. The black image-forming layer was then measured for thickness. As a result, the black image-forming layer was confirmed to have a thickness of 0.60 μm on the average. OD/layer thickness is 1.52.

The image-forming layer thus obtained had the following physical properties.

Rz of the surface of the image-forming layer was 0.71 μm.

The image-forming layer has a surface hardness of preferably 10 g or more with a sapphire needle, and in some detail, the image-forming layer had a surface hardness of 200 g or more.

The image-forming layer has a surface Smoothster value of preferably from 0.5 to 50 mmHg (approximately equal to 0.0665 to 6.65 kPa) at 23° C. and 55% RH. In some detail, the image-forming layer had a surface Smoothster value of 9.3 mmHg (approximately equal to 1.24 kPa).

The image-forming layer has a surface static friction coefficient of preferably 0.8 or less, and in some detail, the image-forming layer had a surface static friction coefficient of 0.08.

The image-forming layer had a surface energy of 29 mJ/m². The image-forming layer had a contact angle of 94.8° with respect to water.

The image-forming layer exhibited a percent deformation of 168% in the light-to-heat conversion layer when recording was effected at a linear rate of not smaller than 1 m/sec with a laser light having a luminous intensity of not smaller than 1,000 W/mm² on the exposed surface.

Preparation of Heat Transfer Sheet Y

A heat transfer sheet Y was prepared in the same manner as the heat transfer sheet K except that the yellow image-forming layer coating solution having the following formulation was used instead of the black image-forming layer coating solution. The heat transfer sheet Y thus obtained had an image-forming layer having a thickness of 0.42 μm.

[Formulation of Mother Liquor of Yellow Pigment Dispersion]

Formulation 1 of Yellow Pigment:

| | | |
|---|---|---|
| Polyvinyl butyral | 7.1 | parts |
| (“Eslec B BL-SH”, produced by SEKISUI | | |
| CHEMICAL CO., LTD.) | | |
| Pigment Yellow 180 (C.I. No. 21290) | 12.9 | parts |
| (“Novoperm Yellow P-HG”, Clariant Japan | | |
| Co., Ltd.) | | |
| Dispersing aid (“Solsperse S-20000”, | 0.6 | parts |
| produced by ICI Co., Ltd.) | | |
| n-Propyl alcohol | 79.4 | parts |

[Formulation of Mother Liquor of Yellow Pigment Dispersion]

Formulation 2 of Yellow Pigment:

| | | |
|---|---|---|
| Polyvinyl butyral | 7.1 | parts |
| (“Eslec B BL-SH”, produced by SEKISUI | | |
| CHEMICAL CO., LTD.) | | |
| Pigment Yellow 139 (C.I. No. 56298) | 12.9 | parts |
| (“Novoperm Yellow M2R 70”, Clariant Japan | | |
| Co., Ltd.) | | |
| Dispersing aid (“Solsperse S-20000”, | 0.6 | parts |
| produced by ICI Co., Ltd.) | | |
| n-Propyl alcohol | 79.4 | parts |

[Formulation of Yellow Image-Forming Layer Coating Solution]

| | |
|---|---|
| Mother liquor of yellow pigment | 126 parts |
| dispersion mentioned above | |

Formulation 1 of yellow pigment: Formulation 2 of yellow pigment=95:5 (parts)

| | | |
|---|---|---|
| Polyvinyl butyral | 4.6 | parts |
| (“Eslec B BL-SH”, produced by SEKISUI | | |
| CHEMICAL CO., LTD.) | | |
| Wax-based compound | | |
| Neutron 2 (amide stearate, produced by | 0.7 | parts |
| Nippon Fine chemical Co., Ltd.) | | |
| Diamide BM (amide behenate, produced by | 0.7 | parts |
| Nippon Chemical Co., Ltd.) | | |
| Diamide Y (amide laurate, produced by | 0.7 | parts |
| Nippon Chemical Co., Ltd.) | | |
| Diamide KP (amide palmitate, produced by | 0.7 | parts |
| Nippon Chemical Co., Ltd.) | | |
| Diamide L-200 (amide erucate, produced by | 0.7 | parts |
| Nippon Chemical Co., Ltd.) | | |
| Diamide O-200 (amide oleate, produced by | 0.7 | parts |
| Nippon Chemical Co., Ltd.) | | |
| Nonionic surface active agent | 0.4 | parts |
| (“Chemistat 1100”, produced by SANYO | | |
| CHEMICAL INDUSTRIES, LTD.) | | |
| Rosin | 2.4 | parts |
| (“KE-311”, produced by Arakawa Chemical | | |
| Industries, Ltd.) | | |
| Surface active agent | 0.8 | parts |
| (“Megafac F-176PF”; solid content: 20%, | | |
| produced by DAINIPPON INK & CHEMICALS, INC.) | | |
| n-Propyl alcohol | 793 | parts |
| Methyl ethyl ketone | 198 | parts |

The image-forming layer thus obtained had the following physical properties.

Rz of the surface of the image-forming layer was 0.78 μm.

The image-forming layer has a surface hardness of preferably 10 g or with a sapphire needle, and in some detail, the image-forming layer had a surface hardness of 200 g or more.

The image-forming layer has a surface Smoothster value of preferably from 0.5 to 50 mmHg (approximately equal to 0.0665 to 6.65 kPa) at 23° C. and 55% RH, and in some detail, the image-forming layer had a surface Smoothster value of 2.3 mmHg (approximately equal to 0.31 kPa).

The image-forming layer has a surface static friction coefficient of preferably not greater than 0.8, and in some detail, the image-forming layer had a surface static friction coefficient of 0.1.

The image-forming layer had a surface energy of 24 mJ/m². The image-forming layer had a contact angle of 108.1° with respect to water. The image-forming layer exhibited a percent deformation of 150% in the light-to-heat conversion layer when recording was effected at a linear rate of not smaller than 1 m/sec with a laser light having a luminous intensity of not smaller than 1,000 W/mm² on the exposed surface.

Preparation of Heat Transfer Sheet M

A heat transfer sheet M was prepared in the same manner as the heat transfer sheet K except that the magenta image-forming layer coating solution having the following formulation was used instead of the black image-forming layer coating solution. The heat transfer sheet M thus obtained had an image-forming layer having a thickness of 0.38 μm.

[Formulation of Mother Liquor of Magenta Pigment Dispersion]

Formulation 1 of Magenta Pigment:

| | | |
|---|---|---|
| Polyvinyl butyral | 12.6 | parts |
| (“Denkabutyral #2000-L, produced by DENKI | | |
| KAGAKU KOGYO K.K.; Vicat softening point: | | |
| 57° C.) | | |
| Pigment Red 57:1 (C.I. No. 15850:1) | 15.0 | parts |
| (“Symuler Brilliant Carmine 6B-229”, | | |
| produced by DAINIPPON INK & CHEMICALS, INC.) | | |
| Dispersing aid (“Solsperse S-20000”, | 0.6 | parts |
| produced by ICI Co., Ltd.) | | |
| n-Propyl alcohol | 80.4 | parts |

[Formulation of Mother Liquor of Magenta Pigment Dispersion]

Formulation 2 of Magenta Pigment:

| | | |
|---|---|---|
| Polyvinyl butyral | 12.6 | parts |
| (“Denkabutyral #2000-L, produced by DENKI | | |
| KAGAKU KOGYO K.K.; Vicat softening point: | | |
| 57° C.) | | |
| Pigment Red 57:1 (C.I. No. 15850:1) | 15.0 | parts |
| (“Lionol Red 6B-4290F”, produced by | | |
| TOYO INK MFG. CO., LTD.) | | |
| Dispersing aid (“Solsperse S-20000”, | 0.6 | parts |
| produced by ICI Co., Ltd.) | | |
| n-Propyl alcohol | 79.4 | parts |

[Formulation of Magenta Image-Forming Layer Coating Solution]

| | | |
|---|---|---|
| Mother liquor of magenta pigment | 163 | parts |
| dispersion mentioned above | | |
| Formulation 1 of magenta pigment:Formulation 2 of | | |
| magenta pigment = 95:5 (parts) | | |
| Polyvinyl butyral | 4.0 | parts |
| (“Denkabutyral #2000-L, produced by DENKI | | |
| KAGAKU KOGYO K.K.; Vicat softening point: | | |
| 57° C.) | | |

Wax-Based Compound

| | | |
|---|---|---|
| Neutron 2 (amide stearate, produced by | 1.0 | parts |
| Nippon Fine chemical Co., Ltd.) | | |
| Diamide BM (amide behenate, produced by | 1.0 | parts |
| Nippon Chemical Co., Ltd.) | | |
| Diamide Y (amide laurate, produced by | 1.0 | parts |
| Nippon Chemical Co., Ltd.) | | |
| Diamide KP (amide palmitate, produced by | 1.0 | parts |
| Nippon Chemical Co., Ltd.) | | |
| Diamide L-200 (amide erucate, produced by | 1.0 | parts |
| Nippon Chemical Co., Ltd.) | | |
| Diamide O-200 (amide oleate, produced by | 1.0 | parts |
| Nippon Chemical Co., Ltd.) | | |
| Nonionic surface active agent | 0.7 | parts |
| (“Chemistat 1100”, produced by SANYO | | |
| CHEMICAL INDUSTRIES, LTD.) | | |
| Rosin | 4.6 | parts |
| (“KE-311”, produced by Arakawa Chemical | | |
| Industries, Ltd.) | | |
| Pentaerythritol tetraacrylate | 2.5 | parts |
| “NK Ester A-TMMT”, produced by Shinnakamura | | |
| Chemical Co., Ltd.) | | |
| Surface active agent | 1.3 | parts |
| (“Megafac F-176PF”; solid content: 20%, | | |
| produced by DAINIPPON INK & CHEMICALS, INC.) | | |
| n-Propyl alcohol | 848 | parts |
| Methyl ethyl ketone | 246 | parts |

The image-forming layer thus obtained had the following physical properties.

Rz of the surface of the image-forming layer was 0.87 μm.

The image-forming layer has a surface hardness of preferably 10 g or more with a sapphire needle, and in some detail, the image-forming layer had a surface hardness of 200 g or more.

The image-forming layer has a surface Smoothster value of preferably from 0.5 to 50 mmHg (approximately equal to 0.0665 to 6.65 kPa) at 23° C. and 55% RH, and in some detail, the image-forming layer had a surface Smoothster value of 3.5 mmHg (approximately equal to 0.47 kPa).

The image-forming layer has a surface static friction coefficient of preferably 0.8 or less, and in some detail, the image-forming layer had a surface static friction coefficient of 0.08.

The image-forming layer had a surface energy of 25 mJ/m². The image-forming layer had a contact angle of 98.8° with respect to water. The image-forming layer exhibited a percent deformation of 160% in the light-to-heat conversion layer when recording was effected at a linear rate of 1 m/sec or more with a laser light having a luminous intensity of 1,000 W/mm² or more on the exposed surface.

Preparation of Heat Transfer Sheet C

A heat transfer sheet C was prepared in the same manner as the heat transfer sheet K except that the cyan image-forming layer coating solution having the following formulation was used instead of the black image-forming layer coating solution. The heat transfer sheet C thus obtained had an image-forming layer having a thickness of 0.45 μm.

[Formulation of Mother Liquor of Cyan Pigment Dispersion]

Formulation 1 of Cyan Pigment:

| | | |
|---|---|---|
| Polyvinyl butyral | 12.6 | parts |
| (“Eslec B BL-SH”, produced by SEKISUI | | |
| CHEMICAL CO., LTD.) | | |
| Pigment Blue 15:4 (C.I. No. 74160) | 15.0 | parts |
| (“Cyanine Blue 700-10FG”, produced by | | |
| TOYO INK MFG. Co., Ltd.) | | |
| Dispersing aid (“PW-36”, phosphoric acid | 0.8 | parts |
| ester-based surface active agent, produced | | |
| Kusumoto Chemicals Co., Ltd.) | | |
| n-Propyl alcohol | 110 | parts |

[Formulation of Mother Liquor of Cyan Pigment Dispersion]

Formulation 2 of Yellow Pigment:

| | | |
|---|---|---|
| Polyvinyl butyral | 12.6 | parts |
| (“Eslec B BL-SH”, produced by SEKISUI | | |
| CHEMICAL CO., LTD.) | | |
| Pigment Blue 15 (C.I. No. 74160) | 15.0 | parts |
| (“Lionol Blue 7027)”, produced by TOYC | | |
| INK MFG. Co., LTD.) | | |
| Dispersing aid (“PW-36”, phosphoric acid | 0.8 | parts |
| ester-based surface active agent, produced | | |
| Kusumoto Chemicals Co., Ltd.) | | |
| n-Propyl alcohol | 110 | parts |

[Formulation of Cyan Image-Forming Layer Coating Solution]

| | | |
|---|---|---|
| Mother liquor of cyan pigment | 118 | parts |
| dispersion mentioned above | | |
| Formulation 1 of cyan pigment:Formulation 2 of cyan | | |
| pigment = 90:10 (parts) | | |
| Polyvinyl butyral | 5.2 | parts |
| (“Eslec B BL-SH”, produced by SEKISUI | | |
| CHEMICAL CO., LTD.) | | |
| Inorganic pigment “MEK-ST” | 1.3 | parts |

Wax-Based Compound

| | | |
|---|---|---|
| Neutron 2 (amide stearate, produced by | 1.0 | parts |
| Nippon Fine chemical Co., Ltd.) | | |
| Diamide BM (amide behenate, produced by | 1.0 | parts |
| Nippon Chemical Co., Ltd.) | | |
| Diamide Y (amide laurate, produced by | 1.0 | parts |
| Nippon Chemical Co., Ltd.) | | |
| Diamide KP (amide palmitate, produced by | 1.0 | parts |
| Nippon Chemical Co., Ltd.) | | |
| Diamide L-200 (amide erucate, produced by | 1.0 | parts |
| Nippon Chemical Co., Ltd.) | | |
| Diamide O-200 (amide oleate, produced by | 1.0 | parts |
| Nippon Chemical Co., Ltd.) | | |
| Rosin | 2.8 | parts |
| (“KE-311”, produced by Arakawa Chemical | | |
| Industries, Ltd.) | | |
| Pentaerythritol tetraacrylate | 1.7 | parts |
| (“NK Ester A-TMMT”, produced by Shinnakamura | | |
| Chemical Co., Ltd.) | | |
| Surface active agent | 1.7 | parts |
| (“Megafac F-l76PF”; solid content: 20%, | | |
| produced by DAINIPPON INK & CHEMICALS, INC.) | | |
| n-Propyl alcohol | 890 | parts |
| Methyl ethyl ketone | 247 | parts |

The image-forming layer thus obtained had the following physical properties.

Rz of the surface of the image-forming layer was 0.83 μm.

The image-forming layer has a surface hardness of preferably 10 g or more with a sapphire needle, and in some detail, the image-forming layer had a surface hardness of 200 g or more.

The image-forming layer has a surface Smoothster value of preferably from 0.5 to 50 mmHg (approximately equal to 0.0665 to 6.65 kPa) at 23° C. and 55% RH, and in some detail, the image-forming layer had a surface Smoothster value of 7.0 mmHg (approximately equal to 0.93 kPa).

The image-forming layer has a surface static friction coefficient of preferably 0.2 or less, and in some detail, the image-forming layer had a surface static friction coefficient of 0.08.

The image-forming layer had a surface energy of 25 mJ/m². The image-forming layer had a contact angle of 98.80 with respect to water.

The image-forming layer exhibited a percent deformation of 165% in the light-to-heat conversion layer when recording was effected at a linear rate of 1 m/sec or more with a laser light having a luminous intensity of 1,000 W/mm² or more on the exposed surface.

Preparation of Image-Receiving Sheet

The cushioning layer coating solution and the image-receiving layer coating solution having the following formulation were prepared.

[Cushioning Layer Coating Solution]

| | |
|---|---|
| Vinyl chloride-vinyl acetate copolymer | 20 parts |
| (Main binder) (“MPR-TSL”, produced by | |
| NISSHIN CHEMICAL INDUSTRY CO., LTD.) | |
| Plasticizer | 10 parts |
| (“Pallaplex G-40”, produced by CP. | |
| HALL. COMPANY) | |
| Surface active agent (fluorine-based | 0.5 parts |
| surface active agent; coating aid) | |
| (“Megafac F-177, produced by DAINIPPON | |
| INK & CHEMICALS, INC.) | |
| Antistat (quaternary ammonium salt) | 0.3 parts |
| (“SAT-5 Supper (IC)”, Nihon Junyaku | |
| Co., Ltd.) | |
| Methyl ethyl ketone | 60 parts |
| Toluene | 10 parts |
| N,N-dimethylformamide | 3 parts |

[Image-Forming Layer Coating Solution]

| | |
|---|---|
| Polyvinyl butyral | 8 parts |
| (“Eslec B BL-SH”, produced by SEKISUI | |
| CHEMICAL CO., LTD.) | |
| Antistat | 0.7 parts |
| (“Sanstat 2012A”, produced by SANYO | |
| CHEMICAL INDUSTRIES, LTD.) | |
| Surface active agent | 0.1 parts |
| (“Megafac F-177, produced by DAINIPPON | |
| INK & CHEMICALS, INC.) | |
| n-Propyl alcohol | 20 parts |
| Methanol | 20 parts |
| 1-Methoxy-2 -propanol | 50 parts |

Using a small width coating machine, the foregoing cushioning layer coating solution was applied to a white PET support (“Lumirror #130E58”; thickness: 130 μm, produced by TORAY INDUSTRIES, INC.). The coated material was then dried. Subsequently, the foregoing image-receiving layer coating solution was applied to the cushioning layer, and then dried. The coated amount of these coating solutions were adjusted such that the dry thickness of the cushioning layer and the image-receiving layer were about 20 μm and about 2 μm, respectively. The white PET support used was a plastic support having voids made of a laminate (total thickness: 130 μm; specific gravity: 0.8) of a polyethylene terephthalate layer having voids (thickness: 116 μm; voids: 20%) and a titanium oxide-containing polyethylene terephthalate layer (thickness: 7 μm; titanium oxide content: 2%) provided on the both sides thereof. The material thus prepared was wound in the form of roll, and then stored at room temperature for 1 week before used for image recording by the following laser light.

The image-receiving layer thus obtained had the following physical properties.

Rz of the surface of the image-forming layer was 0.6 μm.

The image-receiving layer has a surface roughness Ra of preferably from 0.01 to 0.4 μm, and in some detail, the image-receiving layer had a surface roughness of 0.02 μm.

The image-receiving layer has a surface waviness of preferably not greater than 2 μm, and in some detail, the image-receiving layer had a surface waviness of 1.2 μm.

The image-receiving layer has a surface Smoothster value of preferably from 0.5 to 50 mmHg (approximately equal to 0.0665 to 6.65 kPa) at 23° C. and 55% RH, and in some detail, the image-receiving layer had a surface Smoothster value of 0.8 mmHg (approximately equal to 0.11 kPa).

The image-receiving layer has a surface static friction coefficient of preferably 0.8 or less, and in some detail, the image-receiving layer had a surface static friction coefficient of 0.37.

The image-receiving layer had a surface energy of 29 mJ/m². The image-receiving layer had a contact angle of 87.00 with respect to water.

The longitudinal thermal shrinkage and the crosswise thermal shrinkage of the image-receiving sheet are set forth in Table 2. The measurement of thermal shrinkage is carried out by the following method.

Method for the Measurement of Thermal Shrinkage

A sample having a width of 10 mm and a length of 300 mm is subjected to heat treatment at 150° C. for 30 minutes under a longitudinal load of 3 gf. The dimension of the sample was measured before and after treatment. The thermal shrinkage was then calculated by the following equation.
Thermal shrinkage(%)=(L1−L2)×100/L1
L1: Length before treatment
L2: Length after treatment

Formation of Transfer Image

As an image-forming system there was used one shown in FIG. 4 having as a recording device Luxel FINALPROOF 5600. Using the image-forming sequence of this system and the transferring method to final paper in this system, an image was transferred to final paper.

The image-receiving sheet (56 cm×79 cm) prepared as mentioned above was wound on a rotary drum having a diameter of 38 cm having vacuum section holes having a diameter of 1 mm formed therein (face density of 1 hole per area of 3 cm×8 cm) so that it was vacuum-sucked thereby. Subsequently, the foregoing heat transfer sheet K (black) which had been cut into an area of 61 cm×84 cm was superimposed on the foregoing image-receiving sheet in such an arrangement that it protruded uniformly from the image-receiving sheet. While being squeezed by a squeeze roller, the two sheets were adhered to and laminated with each other by air suction through the section holes. The vacuum degree developed when the section holes are blocked was −150 mmHg (approximately equal to 81.13 kPa) with respect to 1 atm. While the drum was being rotated, the surface of the laminate on the drum was externally irradiated with a beam having a wavelength of 808 nm from a semiconductor laser in such a manner that the beam was converged onto the surface of the light-to-heat conversion layer in a spot having a diameter of 7 μm. The beam was moved in the direction (subsidiary canning) perpendicular to the direction of rotation of the rotary drum (main scanning direction). In this manner, laser image (line image) recording was made on the laminate. The laser irradiation conditions will be described below. As the laser light there was used one formed by a binary multi-beam arrangement made of a parallelogram comprising five lines in the main scanning direction and three rows in the subsidiary scanning direction.
Laser power: 110 mW
Rotary speed of drum: 500 rpm
Subsidiary scanning pitch: 6.35 μm
Ambient temperature and humidity: Three conditions (20° C./40%, 23° C./50%, 26° C./65%)

The exposure drum has a diameter of preferably not smaller than 360 mm, and in some detail, the exposure drum had a diameter of 380 mm.

The image size was 594 mm×841 mm, and the resolution was 2,540 dpi.

The laminate on which laser recording had been made was removed from the drum, and the heat transfer sheet K was then peeled off the image-receiving sheet by hand. As a result, it was confirmed that only the light-irradiated area on the image-forming layer of the heat transfer sheet K had been transferred from the heat transfer sheet K to the image-receiving sheet.

An image was transferred from the various heat transfer sheets, i.e., heat transfer sheet Y, heat transfer sheet M and heat transfer sheet C to the image-receiving sheet in the same manner as mentioned above. The four color images thus transferred were each then transferred to the recording paper to form a multi-color image. As a result, even when laser recording was effected with a laser light comprising a binary multi-beam arrangement at a high energy under various temperature and humidity conditions, a multi-color image having a high quality and a stable transfer density was formed.

In order to transfer the image to final paper, a heat transferring device having a dynamic friction coefficient of from 0.1 to 0.7 with respect to the material of the insertion table, i.e., polyethylene terephthalate and a conveying speed of from 15 to 50 mm/sec was used. The Vickers hardness of the material of the heat roll of the heat transferring device is preferably from 10 to 100, and in some detail, the heat roll had a Vickers hardness of 70.

The image thus obtained exhibited good properties under all the three ambient temperature and humidity conditions.

For the evaluation of optical density, the image transferred to Tokubishi art paper as final paper was measured for optical density (OD) of Y, M, C and K with Y mode, M mode, C mode and K mode, respectively, using a Type X-rite 938 densitometer (produced by X-rite Inc.).

The reflection optical density (OD) and the ratio of OD to thickness of image-forming layer (μm) of the various colors are set forth in Table 1 below.

TABLE 1

| | Reflection optical | |
|---|---|---|
| Color | density (OD) | OD/thickness (μm) |
| Y | 1.01 | 2.40 |
| M | 1.51 | 3.97 |
| C | 1.59 | 3.03 |
| K | 1.82 | 3.03 |

Further, the evaluation of the condition of generation of wrinkle during the transfer to thin paper as final paper was carried out by transferring to light weight coated paper “Henry Coat 64” (basis weight: 64 g/m²) as thin paper at a conveyance speed of 10 mm/sec with the diameter and temperature of the heated roll predetermined as set forth in Table 2. The results are set forth in Table 2.
◯: No wrinkle visually recognized
X: Wrinkle visually recognized

Moreover, the evaluation of the condition of generation of peeling during the transfer to non-coated paper as final paper was carried out by transferring to high quality paper “Green the Great” as non-coated paper at a conveyance speed of 6 mm/sec with the diameter and temperature of the heated roll predetermined as set forth in Table 2. The results are set forth in Table 2.
◯: No peeling visually recognized
X: Peeling visually recognized

A transfer image was formed in the same manner as mentioned above except that as the recording device there was used Proof Setter Spectrum produced by CreoScitex Inc. instead of Luxel FINALPROOF 5600, and as a result, a good image was similarly obtained.

### EXAMPLE 1-2

The conditions of generation of wrinkle during the transfer to thin paper as final paper and the conditions of generation of peeling during the transfer to non-coated paper as final paper were evaluated in the same manner as in Example 1-1 except that the matting agent “SEAHOSTER KE-P150” to be incorporated in the light-to-heat conversion layer coating solution for heat transfer sheet was changed to 3μ crosslinked PMMA powder “MX300” (produced by The Soken Chemical & Engineering Co., Ltd.), Rz of the surface of the heat transfer sheet and the image-receiving sheet were changed as set forth in Table 2, 3μ crosslinked PMMA powder “MX300” (produced by The Soken Chemical & Engineering Co., Ltd.) was added to the image-receiving sheet coating solution in an amount of 0.5 parts and the diameter and temperature of the heated roll for use in the transfer to final paper were predetermined as set forth in Table 2. The results are set forth in Table 2.

### COMPARATIVE EXAMPLE 1-1

The evaluation of the conditions of generation of wrinkle during the transfer to thin paper as final paper and the conditions of generation of peeling during the transfer to non-coated paper as final paper was conducted in the same manner as in Example 1-1 except that the thermal shrinkage of the image-receiving sheet was changed as set forth in Table 2 by changing the film-making temperature of the support of the image-receiving sheet. The results are set forth in Table 2.

### COMPARATIVE EXAMPLES 1-2 to 1-4

The evaluation of the conditions of generation of wrinkle during the transfer to thin paper as final paper and the conditions of generation of peeling during the transfer to non-coated paper as final paper was conducted in the same manner as in Example 1-1 except that the diameter and temperature of the heated roll for use in the transfer to final paper were predetermined as set forth in Table 2. The results are set forth in Table 2.

TABLE 2

| | | | | | | Thermal shrinkage | | | | Transferability | |
|---|---|---|---|---|---|---|---|---|---|---|---|
| | Rz (μm) of surface | | | | | (%) of image- | | Diameter | Temperature | | Non- |
| | Heat transfer | | | | Image- | receiving sheet | | (mm) of | (° C.) of | | coated |
| | sheet | | | | receiving | | Cross- | heated | heated | Thin paper | paper |
| | K | C | M | Y | sheet | Longitudinal | wise | roll | roll | (wrinkle) | (peeling) |
| Example | | | | | | | | | | | |
| 1-1 | 0.71 | 0.83 | 0.87 | 0.78 | 0.6 | 0.84 | 0.20 | 110 | 110 | ◯ | ◯ |
| 1-2 | 2.3 | 2.4 | 2.4 | 2.3 | 2.1 | 0.84 | 0.20 | 300 | 200 | ◯ | ◯ |
| Comparative | | | | | | | | | | | |
| Example | | | | | | | | | | | |
| 1-1 | 0.71 | 0.83 | 0.87 | 0.78 | 0.6 | 1.2 | 1.3 | 110 | 110 | X | ◯ |
| 1-2 | 0.71 | 0.83 | 0.87 | 0.78 | 0.6 | 0.84 | 0.20 | 40 | 110 | X | ◯ |
| 1-3 | 0.71 | 0.83 | 0.87 | 0.78 | 0.6 | 0.84 | 0.20 | 110 | 70 | ◯ | X* |
| 1-4 | 0.71 | 0.83 | 0.87 | 0.78 | 0.6 | 0.84 | 0.20 | 110 | 270 | ◯ | X |

*Not transferred

It is apparent from the results set forth in Table 2 that when Rz of the surface of the heat transfer sheet, Rz of the surface of the image-receiving sheet, the thermal shrinkage of the image-receiving sheet and the diameter and temperature of the heated roll for use in the transfer to final paper fall within the range defined in the present invention, the generation of wrinkle during the transfer to thin paper as final paper and the generation of peeling during the transfer to non-coated paper as final paper are inhibited.

### EXAMPLE 2-1

Preparation of Heat Transfer Sheets K, Y, M and C

Heat transfer sheets K (black), Y (yellow), M (magenta) and C (cyan) were prepared in the same manner as in Example 1-1. The physical properties of the light-to-heat conversion layer and the image-forming layer of the various heat transfer sheets were substantially the same as obtained in Example 1-1, the reflection optical density of the image-forming layer of the heat transfer sheet K was 1.82, the thickness of the image-forming layer of the heat transfer sheet K was 0.60 μm, OD/layer thickness was 3.03, the reflection optical density of the image-forming layer of the heat transfer sheet Y was 1.01, the thickness of the image-forming layer of the heat transfer sheet Y was 0.42 μm, OD/layer thickness was 2.40, the reflection optical density of the image-forming layer of the heat transfer sheet M was 1.51, the thickness of the image-forming layer of the heat transfer sheet M was 0.38 μm, OD/layer thickness was 3.97, the reflection optical density of the image-forming layer of the heat transfer sheet C was 1.59, the thickness of the image-forming layer of the heat transfer sheet K was 0.45 μm, and OD/layer thickness was 3.53.

Preparation of Image-Receiving Sheet

A cushioning layer coating solution having the same formulation as that of Example 1-1 and an image-receiving layer coating solution having the same formulation as that of Example 1-1 were prepared.

Using a small width coater, the aforesaid cushioning layer-forming coating solution was spread over a white PET support (“Lumirror #130E58”, produced by Toray Industries, Inc.; thickness: 130 μm), the coat layer was dried. Subsequently, the image-receiving layer coating solution was spread over the coat layer, and the coat layer was then dried. The spread of the coating solutions were adjusted such that thickness of the cushioning layer and the image-receiving layer dried were about 20 μm and about 2 μm, respectively. The white PET support is a void-containing plastic support composed of a laminate (total thickness: 130 μm; specific gravity: 0.8) of a void-containing polyethylene terephthalate layer (thickness: 116 μm; void: 20%) and titanium oxide-containing polyethylene terephthalate layers (thickness: 7 μm; titanium oxide content: 2%) provided on the both sides thereof. The material thus prepared was wound in a rolled form, stored at room temperature for 1 week, and then used in the following image recording by laser light.

The physical properties of the image-receiving layer were as follows.

The surface roughness Ra is preferably from 0.01 to 0.4 μm, and in some detail, it was 0.02 μm.

The surface waviness of the image-receiving layer is preferably 2 μm or less, and in some detail, it was 1.2 μm.

The Smoothster value of the surface of the image-receiving layer was 0.8 mmHg (0.11 kPa).

The static friction coefficient of the surface of the image-receiving layer is preferably 0.8 or less, and in some detail, it was 0.37.

The surface energy of the image-receiving layer was preferably 29 mJ/m². The contact angle with respect to water was 87.0°.

Formation of Transfer Image

As an image-forming system there was used Luxel FINALPROF 5600, which is a recording device system shown in FIG. 4, and using the image-forming sequence of this system and the transferring method to final paper in this system, an image transferred to final paper was obtained. Further, each one was selected as a pressure-sensitive adhesive roller (hardness of pressure-sensitive adhesive material: 35), a roller was selected from rollers for transporting the heat transfer sheet among conveyance rollers 7 shown in FIG. 2, and a roller was selected from rollers for transporting the image-receiving sheet among conveyance rollers 7 shown in FIG. 2.

The image-receiving sheet prepared as mentioned above (56 cm×79 cm) was wound on and vacuum-sucked to a rotary drum having a diameter of 38 cm having vacuum section holes each having a diameter of 1 mm (surface density: one hole per area of 3 cm×8 cm). Subsequently, the aforesaid heat transfer sheet K (black) which had been cut to a size of 61 cm×84 cm was laminated on the image-receiving sheet in such an arrangement that it protruded uniformly from the image-receiving sheet, and the two layers were then adhered to and laminated on each other while air was being sucked through the section holes and the laminate was being squeezed by squeeze rollers. The degree of vacuum developed when the section holes were closed was −150 mmHg (approximately 81.13 kPa) with respect to 1 atm. A laser light having a wavelength of 808 nm from a semiconductor was then converged onto the surface of the laminate on the aforementioned drum which was being rotated to make a spot having a diameter of 7 μm on the surface of the light-to-heat conversion layer while being moved in the direction (secondary scanning) perpendicular to the direction of rotation of the rotary drum (primary scanning direction) so that laser image (line image) recording was made on the laminate. The laser irradiation conditions are as follows. Further, as the laser light to be used in the present example there was used a laser light composed of multi-beam two-dimensional alignment made of parallelogram formed by five lines in the primary scanning direction and three rows in the secondary scanning direction.

| | |
|---|---|
| Laser pitch: | 110 mW |
| Rotary speed of drum: | 500 rpm |
| Secondary scanning pitch: | 6.35 μm |

Ambient temperature and humidity: Three conditions (20° C.-40%, 23° C.-50%, 26° C.-65%)

As the recording drum there was used one having a diameter of 380 mm.

The image size is 515 mm×728 mm and the resolution is 2,600 dpi.

When the laminate finished with laser recording was withdrawn from the drum and the heat transfer sheet K was then peeled off the image-receiving sheet by hand, it was confirmed that only the irradiated area on the image-forming layer of the heat transfer sheet K had been transferred to the image-receiving sheet.

The image was similarly transferred from the heat transfer sheet Y, the heat transfer sheet M and the heat transfer sheet C to the image-receiving sheet. When the four transferred color images were then transferred to recording paper to form a multi-color image, it was confirmed that even when laser recording is effected with laser light composed of multi-beam two-dimensional arrangement having a high energy under various temperature and humidity conditions, a multi-color image having a good quality and a stable transfer density can be formed.

In order to transfer the image to final paper, a heat transferring device having a dynamic friction coefficient of from 0.1 to 0.7 with respect to the material of the inserting table, which is a polyethylene terephthalate, and a conveyance speed of from 15 to 50 mm/sec was used. The Vickers hardness of the material of the heated roll of the heat transferring device is preferably from 10 to 100, and in some detail, a material having a Vickers hardness of 70 was used.

The image thus obtained remained good under all the three ambient temperature and humidity conditions.

### COMPARATIVE EXAMPLES 2-1 to 2-3

A multi-color image was formed in the same manner as in Example 2-1 except that the Smoothster value of the image-forming layer of the heat transfer sheet, the Smoothster value of the image-receiving layer of the image-receiving sheet and the adhesive material of the pressure-sensitive adhesive roller of the recording device were changed as set forth in Table 3.

In Comparative Examples 2-1 to 2-3, various heat transfer sheets were prepared in the same manner as in Example 2-1 except that the light-to-heat conversion layer was free of matting agent dispersion and various image-receiving sheets were prepared in the same manner as in Example 2-1 except that the thickness of the cushioning layer was changed from 20 μm to 40 μm.

The multi-color images thus obtained were each then visually observed for lacks having a size of 1 mm or more present on an A2 size solid recorded image area. Further, the presence of troubles on the path of conveyance of image-forming material was observed to evaluate conveyability. The results are set forth in Table 3.

TABLE 3

| | | | Image-forming | | | Image-receiving | | | |
|---|---|---|---|---|---|---|---|---|---|
| | | | layer | | | layer | | | |
| | | | | Smoothster | | Smoothster | | Lack on image | |
| | Adhesive material | | | value | | value | | area | |
| | Kind | Hardness | Kind | mmHg | kPa | mmHg | kPa | Number | Conveyability |
| Example 2-1 | Middle | 35 | K | 9.3 | 1.24 | 0.8 | 0.11 | 3 | No trouble |
| | hardness | | Y | 2.3 | 0.31 | | | | |
| | nitrile | | M | 3.5 | 0.47 | | | | |
| | rubber | | C | 7.0 | 0.93 | | | | |
| Comparative | Middle | 35 | K | 0.8 | 0.11 | 0.4 | 0.05 | 31 | No trouble |
| Example 2-1 | hardness | | Y | 0.7 | 0.09 | | | | |
| | nitrile | | M | 0.7 | 0.09 | | | | |
| | rubber | | C | 0.8 | 0.11 | | | | |
| Comparative | Low | 10 | K | 0.8 | 0.11 | 0.4 | 0.05 | Unevaluatable | Non- |
| Example 2-2 | hardness | | Y | 0.7 | 0.09 | | | | conveyable |
| | nitrile | | M | 0.7 | 0.09 | | | | (wound on |
| | rubber | | C | 0.8 | 0.11 | | | | pressure-sensitive |
| | | | | | | | | | adhesive |
| | | | | | | | | | roller) |
| Comparative | High | 100 | K | 0.8 | 0.11 | 0.4 | 0.05 | 50 | No trouble |
| Example 2-3 | hardness | | Y | 0.7 | 0.09 | | | | |
| | nitrile | | M | 0.7 | 0.09 | | | | |
| | rubber | | C | 0.8 | 0.11 | | | | |

It is apparent that the present invention allows good conveyance of image-forming material and provides a transfer image having little lack on image area due to dust.

### EXAMPLE 3-1

Preparation of Heat Transfer Sheets K, Y, M and C

Heat transfer sheets K (black), Y (yellow), M (magenta) and C (cyan) were prepared in the same manner as in Example 1-1. The physical properties of the light-to-heat conversion layer and the image-forming layer of the various heat transfer sheets were substantially the same as obtained in Example 1-1, the reflection optical density of the image-forming layer of the heat transfer sheet K was 1.82, the thickness of the image-forming layer of the heat transfer sheet K was 0.60 μm, OD/layer thickness was 3.03, the reflection optical density of the image-forming layer of the heat transfer sheet Y was 1.01, the thickness of the image-forming layer of the heat transfer sheet Y was 0.42 μm, OD/layer thickness was 2.40, the reflection optical density of the image-forming layer of the heat transfer sheet M was 1.51, the thickness of the image-forming layer of the heat transfer sheet M was 0.38 μm, OD/layer thickness was 3.97, the reflection optical density of the image-forming layer of the heat transfer sheet C was 1.59, the thickness of the image-forming layer of the heat transfer sheet K was 0.45 μm, and OD/layer thickness was 3.53.

Preparation of Image-Receiving Sheet

A cushioning layer coating solution having the same formulation as that of Example 1-1 and an image-receiving layer coating solution having the same formulation as that of Example 1-1 were prepared.

Using a small width coater, the aforesaid cushioning layer-forming coating solution was spread over a white PET support (“Lumirror #130E58”, produced by Toray Industries, Inc.; thickness: 130 μm), the coat layer was dried. Subsequently, the image-receiving layer coating solution was spread over the coat layer, and the coat layer was then dried. The spread of the coating solutions were adjusted such that thickness of the cushioning layer and the image-receiving layer dried were about 20 μm and about 2 μm, respectively. The white PET support is a void-containing plastic support composed of a laminate (total thickness: 130 μm; specific gravity: 0.8) of a void-containing polyethylene terephthalate layer (thickness: 116 μm; void: 20%) and titanium oxide-containing polyethylene terephthalate layers (thickness: 7 μm; titanium oxide content: 2%) provided on the both sides thereof. The material thus prepared was wound in a rolled form, stored at room temperature for 1 week, and then used in the following image recording by laser light.

The physical properties of the image-receiving layer were as follows.

The surface roughness Ra is preferably from 0.01 to 0.4 μm, and in some detail, it was 0.02 μm.

The surface waviness of the image-receiving layer is preferably 2 μm or less, and in some detail, it was 1.2 μm.

The Smoothster value of the surface of the image-receiving layer is preferably 2 μm or less, and in some detail, it was 1.2 μm.

The Smoothster value of the surface of the image-receiving layer is preferably from 0.5 to 50 mmHg (approximately from 0.0665 to 6.65 kPa) at 23° C. and 55% RH, and in some detail, it was 0.8 mmHg (0.11 kPa).

The static friction coefficient of the surface of the image-receiving layer is preferably 0.8 or less, and in some detail, it was 0.37.

The surface energy of the image-receiving layer was preferably 29 mJ/m². The contact angle with respect to water was 87.0°.

Further, Msr and Tsr of the image-receiving sheet obtained were measured.

Formation of Transfer Image

As an image-forming system there was used Luxel FINALPROF 5600, which is a recording device system shown in FIG. 4, and using the image-forming sequence of this system and the transferring method to final paper in this system, an image transferred to final paper was obtained.

The image-receiving sheet prepared as mentioned above (56 cm×79 cm) was wound on and vacuum-sucked to a rotary drum having a diameter of 38 cm having vacuum section holes each having a diameter of 1 mm (surface density: one hole per area of 3 cm×8 cm). Subsequently, the aforesaid heat transfer sheet K (black) which had been cut to a size of 61 cm×84 cm was laminated on the image-receiving sheet in such an arrangement that it protruded uniformly from the image-receiving sheet, and the two layers were then adhered to and laminated on each other while air was being sucked through the section holes and the laminate was being squeezed by squeeze rollers. The degree of vacuum developed when the section holes were closed was −150 mmHg (approximately 81.13 kPa) with respect to 1 atm. A laser light having a wavelength of 808 nm from a semiconductor was then converged onto the surface of the laminate on the aforementioned drum which was being rotated to make a spot having a diameter of 7 μm on the surface of the light-to-heat conversion layer while being moved in the direction (secondary scanning) perpendicular to the direction of rotation of the rotary drum (primary scanning direction) so that laser image (line image) recording was made on the laminate. The laser irradiation conditions are as follows. Further, as the laser light to be used in the present example there was used a laser light composed of multi-beam two-dimensional alignment made of parallelogram formed by five lines in the primary scanning direction and three rows in the secondary scanning direction.

| | |
|---|---|
| Laser pitch: | 110 mW |
| Rotary speed of drum: | 500 rpm |
| Secondary scanning pitch: | 6.35 μm |

Ambient temperature and humidity: Three conditions (20° C.-40%, 23° C.-50%, 26° C.-65%)

As the recording drum there was used one having a diameter of 380 mm.

The image size is 515 mm×728 mm and the resolution is 2,600 dpi.

When the laminate finished with laser recording was withdrawn from the drum and the heat transfer sheet K was then peeled off the image-receiving sheet by hand, it was confirmed that only the irradiated area on the image-forming layer of the heat transfer sheet K had been transferred to the image-receiving sheet.

The image was similarly transferred from the heat transfer sheet Y, the heat transfer sheet M and the heat transfer sheet C to the image-receiving sheet. When the four transferred color images were then transferred to recording paper to form a multi-color image, it was confirmed that even when laser recording is effected with laser light composed of multi-beam two-dimensional arrangement having a high energy under different temperature and humidity conditions, a multi-color image having a good quality and a stable transfer density can be formed.

In order to transfer the image to final paper, a heat transferring device having a dynamic friction coefficient of from 0.1 to 0.7 with respect to the material of the inserting table, which is a polyethylene terephthalate, and a conveyance speed of from 15 to 50 mm/sec was used. The Vickers hardness of the material of the heated roll of the heat transferring device is preferably from 10 to 100, and in some detail, a material having a Vickers hardness of 70 was used.

The image thus obtained remained good under all the three ambient temperature and humidity conditions.

### EXAMPLES 3-2 to 3-3; COMPARATIVE EXAMPLES 3-1 to 3-2

Multi-color images were prepared in the same manner as in Example 3-1 except that the stiffness and/or Rz of the image-receiving sheet and/or recording drum and/or the diameter of the recording drum were changed. These changes were carried out by changing the recording drum or the formulation of image-receiving sheet.

The quality of the multi-color images thus obtained were evaluated as follows, and the results are set forth in Table 4.
⊚: More uniform high image quality obtained;
◯: Practicable image quality obtained;
X: Image unevenness generated, image quality deteriorated;

XX: Image unevenness generated, image quality deteriorated more;

TABLE 4

| | | | | Rz (μm) of | | Diameter | |
|---|---|---|---|---|---|---|---|
| | | | | image- | Rz (μm) of | (mm) of | |
| | | | | receiving | recording | recording | Image |
| | Msr | Tsr | Msr/Tsr | sheet | drum | drum | quality |
| Example 3-1 | 73.5 | 72.5 | 1.014 | 0.6 | 8.1 | 380 | ⊚ |
| Example 3-2 | 68.0 | 65.7 | 1.035 | 1.5 | 9.58 | 300 | ⊚ |
| Example 3-3 | 58.0 | 67.5 | 0.859 | 3.4 | 8.1 | 380 | ◯ |
| Comparative | 32.0 | 32.6 | 0.982 | 15.2 | 8.1 | 380 | XX |
| Example 3-1 | | | | | | | |
| Comparative | 73.0 | 72.8 | 1.003 | 15.2 | 8.1 | 380 | X |
| Example 3-2 | | | | | | | |

It is apparent that the present invention provides a high quality multi-color image.

### INDUSTRIAL APPLICABILITY

In accordance with the present invention, a laser heat transfer recording system for DDCP comprising a pigment type B2 size image-forming material capable of being transferred to final paper and outputting actual halftone dot, an outputting machine and a high quality CMS software can be realized which can clear the problems with the related art laser heat transfer system on the basis of thin film transfer technique and realize sharp dots using a thin film heat transfer system involving the aforementioned various techniques to give a higher image quality, making it possible to realize a system configuration which can perform the properties of a material having a high resolution. In some detail, a contract proof that substitutes for proof sheet or analog color proof can be provided to meet the CTP era's requirements for elimination of film, and this proof allows the reproduction of colors coinciding with that of printed matter or analog color proof to be provided to customers for approval. The system of the present invention can use the same pigment-based colorants as printing ink and allows transfer to final paper, making it possible to provide DDCO system free from Moire pattern or the like. Further, in accordance with the present invention, a large size (A2/B2 or more) digital direct color proof system which allows the use of the same pigment-based colorants as printing ink during transfer to final paper to realize a high approximation to printed matter can be provided. The present invention is suitable for transferring to final paper with recording an actual halftone dot by using laser thin film heat transfer process with pigment colorants and transfer of image to final paper and thus allows the formation of an image having a good quality and a stable transfer density on the image-receiving sheet even when laser recording is effected with a laser light composed of multi-beam two-dimensional arrangement at a high energy under various temperature and humidity conditions. In particular, in accordance with the present invention, a multi-color image-forming process which is less subject to generation of wrinkle during the transfer to thin paper as final paper and generation of peeling during the transfer to non-coated paper as final paper and thus exhibits an improved transferability to final paper, a multi-color image-forming process capable of providing a transfer image having little lack due to dust, and a multi-color image-forming process which gives an excellent adhesion between the recording drum and the image-receiving sheet and the image-receiving sheet and the heat transfer sheet to obtain a stable high image quality are provided.

1. A multi-color image recording process, which comprises:
a step (I) of rolling out a rolled heat transfer sheet having a light-to-heat conversion layer and an image-forming layer, and a rolled image-receiving sheet having an image-receiving layer, the image-receiving sheet being wound with the image-receiving layer outside, into an exposure recording device; superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other; and retaining the superposed heat transfer sheet and the image-receiving sheet on an exposure drum of the exposure recording device;
a step (II) of transferring an image to the image-receiving sheet by a heat converted from a laser light, the laser light being absorbed in the light-to-heat conversion layer of the heat transfer sheet upon irradiation with the laser light according to image data; and
a step (III) of retransferring the image which has been transferred to the image-receiving sheet to a final image carrier,
wherein a) the image-forming layer in the heat transfer sheet has a surface having Rz of 0.5 to 2.5 μm, b) the image-receiving layer in the image-receiving sheet has a surface having Rz of 0.5 to 1.5 μm, c) the image-receiving sheet has a longitudinal thermal shrinkage of 1.0% or less and a crosswise thermal shrinkage of 1.0% or less, and d) in the step (III) of retransferring the image to the final image carrier, the retransferring is effected by using a pair of heated rolls each having a diameter ranging from 50 mm to 350 mm wherein the rolls are set to a temperature of 80° C. to 250° C.

2. A multi-color image-forming process, which comprises:
rolling out a rolled heat transfer sheet and a rolled image-receiving sheet having a image-receiving layer, the image-receiving sheet being wound with the image-receiving layer outside;
superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other;
retaining the superposed heat transfer sheet and the image-receiving sheet on a recording drum; and
transferring an image to the image-receiving sheet by a heat converted from a laser light, the laser light being absorbed in the light-to-heat conversion layer of the heat transfer sheet upon irradiation with the laser light according to image data, so that the image is formed on the image-receiving sheet;
wherein the multi-color image-forming process comprises a step of cleaning a surface of the heat transfer sheet and a surface of the image-receiving sheet by bringing the heat transfer sheet and the image-receiving sheet into contact with a pressure-sensitive adhesive roller having a pressure-sensitive adhesive material on a surface of the roll, the pressure-sensitive adhesive roller being provided either at a section where the heat transfer sheet is fed or transported, or at a section where the image-receiving sheet is fed or transported;
the pressure-sensitive adhesive roller has a pressure-sensitive adhesive material having a hardness (JIS-A) of 15 to 90;
the heat transfer sheet comprises a image-forming layer having a Smoothster value of 1.0 to 20 mmHg (0.13 to 2.7 kPa); and
the image-receiving layer has a surface having a Smoothster value of 0.5 to 30 mmHg (0.07 to 4.0 kPa).

3. A multi-color image-forming process, which comprises:
rolling out a rolled heat transfer sheet and a rolled image-receiving sheet having a image-receiving layer, the image-receiving sheet being wound with the image-receiving layer outside;
superposing, after cutting the heat transfer sheet and the image-receiving sheet to a predetermined length, the heat transfer sheet and the image-receiving sheet on each other with the outer surface of the image-forming layer and the outer surface of the image-receiving layer faced to each other;
retaining the superposed heat transfer sheet and the image-receiving sheet on a recording drum; and
transferring an image to the image-receiving sheet by a heat converted from a laser light, the laser light being absorbed in the light-to-heat conversion layer of the heat transfer sheet upon irradiation with the laser light according to image data, so that the image is formed on the image-receiving sheet;
wherein the image-receiving sheet has a longitudinal stiffness (Msr) of 40 to 90 g, a crosswise stiffness (Tsr) of 40 to 90 g, and an Msr/Tsr of 0.7 to 1.20; the recording drum has a surface having a surface roughness of 0.10 to 12 μm in terms of Rz value and the image-receiving has a surface having a surface roughness of 0.10 to 12 μm in terms of Rz value; and
the recording drum has a diameter of 250 mm or more.

4. The multi-color image-forming process as claimed in any one of claims 1 to 3, wherein the image-forming layer in the heat transfer sheet has a contact angle of water of 7.0 to 120.0°, and the image-receiving layer in the image-receiving sheet has a contact angle of water of 7.0 to 120.0°.

5. The multi-color image-forming process as claimed in any one of claims 1 to 3 wherein the multi-color image has a recording area of 515 mm or more×728 mm or more.

6. The multi-color image-forming process as claimed in any one of claims 1 to 3, wherein the image-forming layer in the heat transfer sheet has a ratio (OD/layer thickness) of the optical density (OD) to the thickness (μm) of 1.80 or more, and the image-receiving sheet has a contact angle of water of 86° or less.
